(19) United States
(12) Patent Application Publication
(10) Pub. No.: US 2023/0176246 A1
(43) Pub. Date: Jun. 8, 2023

(54) SYSTEM FOR IMMUTABILITY VERIFYING, RECORDING AND STORING DIGITAL REPRESENTATION OF OBJECTS AND EVENTS

(71) Applicant: Scientia Potentia Est II, LLC, Charleston, SC (US)

(72) Inventors: Jeremy Blackburn, Charleston, SC (US); Justin Southward, Fort Meyers, FL (US); W. Kurt Taylor, N. Charleston, SC (US); Karl David, Charleston, SC (US); Austi Critchfield, Clearwater, FL (US); Michael Lu, N. Charleston, SC (US); Tim McVicker, Charleston, SC (US); Bryan McArdle, Charleston, SC (US)

(73) Assignee: Scientia Potentia Est II, LLC, Charleston, SC (US)

(21) Appl. No.: 17/959,923

(22) Filed: Oct. 4, 2022

Related U.S. Application Data
(63) Continuation-in-part of application No. 17/900,624, filed on Aug. 31, 2022.
Application No. 17/900,624 is a continuation-in-part of application No. 17/866,256, filed on Jul. 15, 2022.
Application No. 17/866,256 is a continuation-in-part of application No. 17/697,839, filed on Mar. 17, 2022.
Application No. 17/697,839 is a continuation-in-part of application No. 17/686,502, filed on Mar. 4, 2022, now Pat. No. 11,610,202.
Application No. 17/686,502 is a continuation-in-part of application No. 17/566,957, filed on Dec. 31, 2021.
Application No. 17/566,957 is a continuation-in-part of application No. 17/561,827, filed on Dec. 24, 2021, now Pat. No. 11,574,319.
Application No. 17/561,827 is a continuation-in-part of application No. 17/531,746, filed on Nov. 20, 2021, now Pat. No. 11,482,325.
Application No. 17/531,746 is a continuation-in-part of application No. 17/531,598, filed on Nov. 19, 2021.
Application No. 17/531,598 is a continuation-in-part of application No. 17/344,043, filed on Jun. 10, 2021.
Application No. 17/344,043 is a continuation-in-part of application No. 17/230,911, filed on Apr. 14, 2021, now Pat. No. 11,288,761.
Application No. 17/230,911 is a continuation-in-part of application No. 17/176,056, filed on Feb. 15, 2021, now Pat. No. 11,288,308.
Application No. 17/176,056 is a continuation-in-part of application No. 17/128,084, filed on Dec. 19, 2020, now Pat. No. 11,521,157.
Application No. 17/128,084 is a continuation-in-part of application No. 16/997,840, filed on Aug. 19, 2020, now Pat. No. 11,449,949.
Application No. 16/997,840 is a continuation-in-part of application No. 16/994,585, filed on Aug. 15, 2020, now Pat. No. 11,232,652.
Application No. 16/994,585 is a continuation-in-part of application No. 16/991,916, filed on Aug. 12, 2020, now Pat. No. 11,216,823.
Application No. 16/991,916 is a continuation-in-part of application No. 16/876,080, filed on May 17, 2020, now Pat. No. 11,423,360.
Application No. 16/876,080 is a continuation-in-part of application No. 16/810,782, filed on Mar. 5, 2020, now Pat. No. 11,216,781.
Application No. 16/810,782 is a continuation-in-part of application No. 16/510,642, filed on Jul. 12, 2019, now Pat. No. 11,216,772.
Application No. 16/510,642 is a continuation-in-part of application No. 16/510,634, filed on Jul. 12, 2019, now Pat. No. 10,713,737.
Application No. 16/510,634 is a continuation-in-part of application No. 16/452,076, filed on Jun. 25, 2019, now abandoned.
Application No. 16/510,642 is a continuation-in-part of application No. 16/452,076, filed on Jun. 25, 2019, now abandoned.

(51) Int. Cl. G01W 1/00

(52) U.S. Cl. CPC G01W 1/00; G01W 1/02

(57) ABSTRACT

This computerized system can include a computer system in communication with an immutable storage; a first computer device and a second computer device can be in communications with the computer system; a set of computer readable instructions can be included in the computer system configured for receiving a first event record including a first location, a first time and a first set of metadata wherein the first set of metadata includes an original digital representation captured by the first computer device of the physical object, receiving a subsequent event record from the second computer device and, determining if the original digital representation is equivalent to the subsequent digital representation thereby providing for verification that the same physical object transitioned from an originating event to a subsequent event.

### RELATED APPLICATIONS

This application is a continuation in part of U.S. patent application Ser. No. 17/900,624 filed Aug. 31, 2022, which is a continuation in part of U.S. patent application Ser. No. 17/866,256 filed Jul. 18, 2022, which is a continuation in party of U.S. patent application Ser. No. 17/697,839 filed Mar. 17, 2022, which is a continuation in part of Ser. No. 17/686,502 filed Mar. 4, 2022, which is a continuation in part of U.S. patent application Ser. No. 17/566,957 filed Dec. 31, 2021 which is in turn a continuation in part of U.S. patent application Ser. No. 17/561,827 filed Dec. 24, 2021 which is in turn a continuation in part of U.S. application Ser. No. 17/531,746 filed Nov. 20, 2021 which is in turn a continuation in part of U.S. application Ser. No. 17/531,598 filed Nov. 19, 2021 which in turn is a continuation in part of U.S. application Ser. No. 17/344,043 filed Jun. 10, 2021 which in turn is a continuation in part of U.S. application Ser. No. 17/230,911 filed Apr. 14, 2021 which in turn is a continuation in part of U.S. application Ser. No. 17/176,056 filed Feb. 15, 2021 which in turn is a continuation in part of U.S. application Ser. No. 17/128,084 filed Dec. 19, 2020 which in turn is a continuation in part of U.S. application Ser. No. 16/997,840 filed Aug. 19, 2020, which is a continuation in part of U.S. application Ser. No. 16/994,585 filed Aug. 15, 2020 (now U.S. patent Ser. No. 11/232,652 issued Jan. 25, 2022) which in turn is a continuation in part of U.S. patent application Ser. No. 16/991,916 filed on Aug. 12, 2020 (now U.S. patent Ser. No. 11/216,823 issued Jan. 4, 2022) which in turn is a continuation in part of U.S. patent application Ser. No. 16/876,080 filed May 17, 2020 which in turn is a continuation in part of U.S. patent application Ser. No. 16/810,782 filed on Mar. 5, 2020 (now U.S. patent Ser. No. 11/216,781 issued Jan. 4, 2022) which in turn is a continuation in part of U.S. patent application Ser. No. 16/510,634 filed on Jul. 12, 2019 (now U.S. Pat. No. 10,713,737 issued Jul. 14, 2020) and U.S. patent application Ser. No. 16/510,642 filed on Jul. 12, 2019 (now U.S. patent Ser. No. 11/216,772 issued Jan. 4, 2022), which are all incorporated by reference. Patent application Nos. 16510542 and 16510634 are both continuations of U.S. patent application Ser. No. 16/452,076 filed Jun. 25, 2019, which all are incorporated by reference.

### BACKGROUND

1) Field of the System

A system for immutability verifying, recording, and storing digital representation of physical object and events including associating the object or event with an identifier which can include a unique identifier that is received by the system or created by the system.

2) Background.

With the increasing use of technology, all industries face risk and compliance challenges both with authentication of digital information as well as authentication of such digital information. This is especially true with the increased use of digital technologies such as paperless transactions, financial institution systems, property ownership records, crypto-currencies, digital art, NFT, and the like. Further, technologies such as blockchain that are designed to allow for distributed storage is data without modification to the data are being used for cryptocurrency to increase security reduce risk in alteration of the data as well as to provide for non-fungible tokens (NFT) where the NFT can be associated with digital art.

These new technologies has led to an increased focus on systems that are designed to manage governmental, risk, audit, and compliance (GRC). For example, digitizing governance materials allows access in real-time to industry and competitor data and can assist an organization to act timely on opportunities. Due to the importance of GRC data, secure storage and communications is needed while also allowing the sharing of specific information, both confidentially and publicly, with third parties. While GRC systems are designed to provide for entities to reach key objectives, analyze and evaluate data, proactively spot risks, and take advantage of opportunities in a timelier fashion, they rely on the data that is received without verifications or authentications.

Further, there is a trend for digitization that includes attempts to create digital representations of physical objects so that the physical objects can be properly and accurately represented. Historically, digitization focused on creating a digital scan of a physical object so that the digital information can be manipulated by information systems and stored on a database. For example, a bank balance can be the digital representation of the fiat currency that is in the possession of the bank account holder. A digital photo can be a representation of an oil painting. While these systems are sufficient for fungible objects such as currency, there is a challenge when the object is not fungible. For example, during the manufacturing of a good, components for that good can be specific to that good and are not readily substituted between different goods. Another example is when the digital representation is of a physical object that has unique significance such as sports memorabilia (e.g., the XXXth homerun ball). Therefore, traditional methods of tracking objects such as with barcodes are not sufficient. The barcode, for example, does not necessarily capture the changes to the object nor transactions or events that are associated with the object. The barcode cannot record events that are associated with an object such as repairs. This disadvantage is evident when a replacement part is used that, while using the same barcode, the replacement part is recorded as the original part losing valuable information about the object.

Using existing technology taken from industries such as the financial industry does not solve the problem as they cannot verifiably pair a digital representation with a physical object. In the financial industry, digitization begins with electronic information representing the dollar value of an account and not a specific physical dollar itself. As the financial industry progressed, the electronic currency itself became the asset as discussed in U.S. Pat. No. 9,135,787, this patent discloses a Bitcoin kiosk/ATM that facilitates the buying or selling of Bitcoin. Blockchain, the underlying technology of Bitcoin, cannot verifiably pair a digital representation with a physical object because there is no linkage between the physical object and the digital asset. While blockchain can provide immutable data storage, it cannot pair a physical object with its digital representation.

Another disadvantage of blockchain is that the inability to verify transactions is generally limited to miners wherein the mining process is essentially the verification of a transaction. A transaction is the verification of preceding data blocks as well as confirmation of the current block. There have been some attempts to create verification systems, but none has proven to have sufficient accuracy needed for commercialization of these systems. For example, U.S. Pat. No. 10,790,963 uses a pattern count calculator that calculates the number of transaction patterns for a generating party using the blockchain generation apparatus. This requires that an identifier of the generating party is used with a block generation condition checker to determine whether the generating party is qualified to generate the new blockchain data.

Proper digitization involves the digital information representing the physical asset. The current state of the art only includes electronic scanning of physical assets which is not authentication or verifications. Electronic scanning simply creates a digital copy that is separate from the physical object and becomes an independent object itself. Despite the illegality of this example, the digital scan of US currency and the US currency itself are not equivalent. The US currency can be spent without reference or modification of the digital scan and the digital scan can be manipulated without reference or modifications to the US currency. The inability to pair the digital representation with physical object makes traditional digitization of physical objects challenging as the digital object and the digital representation are not functional equivalents and therefore inadequate.

The ability to track objects during a process can be improved when the object is properly paired with a digital representation. In many industries, the systematic and logical workflow of physical objects increases the success of any project, process, activity, or providing a service. There is also a need to verify past and current transactions that are stored on an immutable ledger. Currently, there is a lack of accountability, verification and reliability between physical objects and digital representations. The inability to verify the pairing of physical objects with digital representations negatively impacts current processes, increases risks, and increases costs in general. While there have been some attempts to add item information to a physical material, such as U.S. Pat. No. 8,321,302, these attempts have focused on tracking inventory levels and do not include verifiably pairing a physical object with a digital representation. Further, these prior attempts focus on the identifier and not the physical object itself. Therefore, there is no assurance that the identifier remains associated with the physical object nor the ability to verify that it remains associated after the initial storage. This disadvantage can be seen in U.S. Pat. No. 8,521,620 which specifically states that if a RFID tag is lost or damaged, the system allows a user to enter an item number or style and tags of similar items are displayed, a new tag is generated and associated with the item having the lost or damaged tag. The ability to change RFID tags expressly shows that the physical object is not paired with the digital representation.

There have also been attempts to use inspections to assist with monitoring physical objects during a process. There have been attempts to provide for automated inspection such as U.S. Pat. No. 7,508,973 which discloses method of inspecting detects includes assigning a plurality of sets of image acquisition conditions, executing inspection using each of the sets of conditions, classifying all detected defects into real defects and false defects by use of an automatic defect classification function, and selecting, from the plurality of sets of conditions, a set of conditions ideal for detection. However, this attempt is reduced to a snapshot in time in the products lifecycle. This attempt does not pair the physical object to a digital representation, nor does it provide for an audit trail throughout the process.

These systems do not verify the data stored and associated with the life of a project or process and do not account for the physical goods being detached from the “tag.” The inability to verify data and that a digital representation is paired with the physical object prevents the use of digital wallets for this purpose since a digital wallet does not include such as pairing. Previous attempts to verify such transactions fail to pair a physical object with a digital representation, disadvantages that can be seen in United States Patent Application Publication 20190303919.

It would be an advantage to have a system that can verify the paring of physical objects with digital representations so that information systems can be used to track physical objects with reduced or eliminated risks that the digital representation no longer represents the original physical object.

It would be advantageous to have a system that can provide for multi-party verification of the pairing of a physical asset with a digital representation for tracking of the physical asset and the associated project.

### SUMMARY OF THE SYSTEM

The computerized system can include a system for digitally recording, verifying, and storing objects and events comprising: a computer device in communications with an immutable storage system; a capture device in communication with the computer device; a set of computer readable instructions that when processed by the computer device are adapted to: receive a user information representing a user of the computer device, capture an object information representing an object using the capture device wherein the object information includes object metadata according to an object location information and an object temporal information, capture an event identification information representing an event wherein the event identification information includes event metadata according to an event location information and an event temporal information, create a capture record according to the user information, object information, event information, and any combination thereof, and store the capture record on the immutable storage system.

The system can include a digital storage and the set of computer readable instructions are adapted to associate the digital storage with the user information and associate the capture record with the digital storage. The set of computer readable instructions can be adapted to receive a unique identifier and associate the unique identifier with the capture record and the digital storage where the system can create the unique identifier. The object can be a physical object and the object information include a digital representation of the physical object. The user information can include user metadata according to user location information and user temporal information. The set of computer readable instructions can create validation information according to a comparison of the object metadata and the event metadata. The user information can include user metadata according to user location information and user temporal information.

The set of computer readable instructions can be adapted to create validation information according to a comparison of the object metadata, the event metadata, the user information, and any combination thereof. The set of computer readable instructions can be adapted to receive remote temporal information from a remote temporal source and create a verification information according to a comparison of the object temporal information, the remote temporal information, the event temporal information and combination thereof. The computer device can be configured to determine the object information from a global positioning service, wireless access point, cell tower, IP address and any combination thereof at a time the object information is captured. The computer device can be configured to determine the event information from a global positioning service, wireless access point, cell tower, IP address and any combination thereof at a time the event information is captured.

The set of computer readable instructions can include are adapted to create the verification information according to a determination that the object location information and the verification location information are within a predetermined range. The set of computer readable instructions can be adapted to create the verification information according to a determination that the object temporal information and the verification temporal information are within a predetermined range. The set of computer readable instructions can be adapted to receive a second user information representing a second user of the computer device, receive a verification information using the capture device wherein the verification information represents a determination that the event information accurately represents the event, and the verification information includes verification metadata according to a verification location information and a verification temporal information, and create a verification record according to a comparison of the capture record and the verification information.

### BRIEF DESCRIPTION OF THE DRAWINGS

FIG. 1A is a diagram of aspects of the invention;

FIG. 2 is a diagram of aspects of the invention;

FIG. 3 is a diagram of aspects of the invention;

FIG. 4A is a schematic of aspects of the invention;

FIG. 4B is a schematic of aspects of the invention;

FIG. 4C is a schematic of aspects of the invention;

FIG. 5 is a diagram of aspects of the invention;

FIG. 6 is a diagram of aspects of the invention;

FIG. 7 is a diagram of aspects of the invention;

FIG. 8 is a schematic of aspects of the invention;

FIG. 9 is a schematic of aspects of the invention;

FIG. 10 is a diagram of aspects of the invention;

FIG. 11 is a schematic of aspects of the invention;

FIG. 12A is a schematic of aspects of the invention;

FIG. 12B is a schematic of aspects of the invention;

FIG. 13A is a schematic of aspects of the invention;

FIG. 13B is a schematic of aspects of the invention;

FIG. 13C is a schematic of aspects of the invention;

FIG. 13D is a schematic of aspects of the invention;

FIG. 14A is a flowchart of aspects of the invention;

FIG. 14B is a flowchart of aspects of the invention;

FIG. 14C is a flowchart of aspects of the invention;

FIG. 14D is a flowchart of aspects of the invention; and,

FIG. 14E is a flowchart of aspects of the invention.

### DETAILED DESCRIPTION

The present system provides for verified pairing of a physical object with a digital representation. The system can include a computer device, capture device and computer readable instructions that can provide for computer systems that can be in communications with an internal database, a second database, a immutable storage system and any combination. Each of the data storage systems can be centralized, decentralized, immutable, distributed, local, remote, shared, private, virtual and any combination. The first data storage system can differ from the second data storage system. The first and second data storage systems can be immutable and persistent so that the information stored on the data system, once storage, cannot be changed. The data systems can include a plurality of computer systems where data can be copied onto each computer system. Examples of data storage platforms include hard drives, solid state drives, tapes, and cloud storage systems. The immutable data storage system can use blockchain, crypto-shredding, WORM, append only, distributed ledger technology, immutable cloud storage, immutable record retention (e.g., Oracle Cloud Infrastructure Object Storage, Quantum Ledger Database, and any combination thereof). In one embodiment the immutability is accomplished by the data storage system only allowing records to be appended to the storage media without the ability to modify the record once written. One such system includes blockchain.

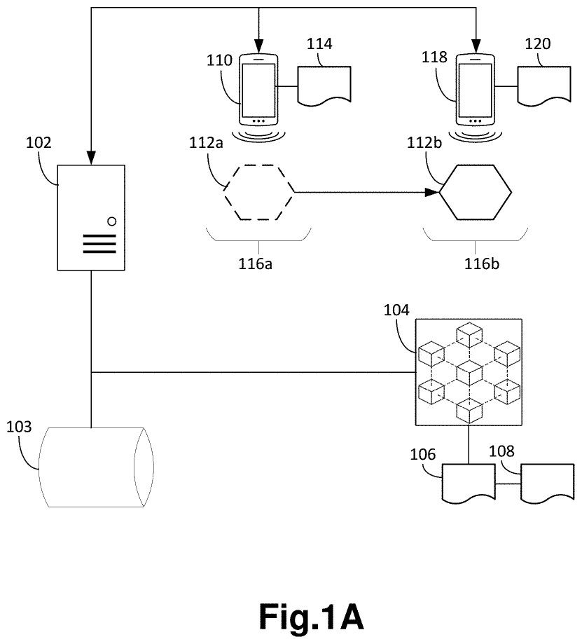

Referring to FIG. 1A, computer device 102 can be in communication with a database 103. A first record 114 can be associated with a first object or event 116a and a second record 120 can be associated with a second event 116b. The system can also capture and store user information, object information and event information which can be in the form of records. The captured information can be performed at a first time represented by 112a and at a second time represented by 112b. Additional computer device and capture device 110 and 118 can be used to capture information in this system.

In one embodiment, the order in which the first record and the second record are written on the immutable storage can be used to show that some period of time elapsed between the first record and the second record. This functionality can add to the verification process as attempts to improperly tamper with the immutable storage may be discovered when the first record and the second record are not in chronological order. This functionality can also apply to, include, and verify items, people, places, association, activities, events as well as confirm previous recording and storage of such information. For example, the system can capture user information, object information, event information and any combination such as capturing a digital representation of a physical object. The system can create a capture record representing the verified association of the digital representation with the physical object. The system can capture and record subsequent information about the object or event such as a subsequent transaction (e.g., in person authentication). A second capture record can be created and associated with the first capture record creating a history of objects and events. When this information is captured and stored, attempts to improperly tamper with the immutable storage can be discovered when the metadata of the first record and the second record are inconsistent with the first record and the second record as stored.

The first event record can be associated with a first event and the second event record can be associated with a second event. The data associated with these events can be retrieved from the capture device and used in creating and writing the associated event record. If the date and time setting of the computer device are incorrect, this discrepancy can be identified by comparison with the event record created and compared to related records in the immutable storage. In one embodiment, metadata integrity used by the system can be designed to identify inconsistencies with date and time. For example, a capture sensor such as a camera, scanner or other input device can be used to capture one or more images from an object or project, such as materials at a construction site. The data can include metadata associated with user, object, or event. Any error or inconsistency in the respective metadata can be identified by comparing the metadata and the hash/block time of the metadata that was committed to the immutable storage system. The difference can be a discrete comparison or can be a determination that the information is within a range. The verification can be used to create a verification record. When there are inconsistencies, notifications can be sent to a user. This notification allows the users to remedy any consistencies as well as determine authentication and verifications. and mitigate such errors in the future.

The first event can differ from the second event by time, activity, process, location, or any combination. In one embodiment, metadata associated with the event and event record and a ledger hash time, representing when the event record is stored (e.g., committed) to the immutable storage can be used to validate the metadata provided from the computer device. If the computer has an incorrect time, a comparison of the ledger hash time with the metadata from the computer device can identify an error. Identifying an error can be used to alert users to computer device issues and can indicate that the computer device needs to be serviced or replaced prior to its next use.

In one embodiment, the metadata that can be associated with the capture device can include weather conditions, which can include a sun angle, which can be compared with environmental weather conditions to approximate the data capture time. Metadata associated with an image of video can be used to verify weather conditions in the image or video. Time and location metadata can be retrieved from publicly sources or remote sources and captured with the device metadata to determine of the captured weather in the image or video is the same as being reported locally on that day and at that time.

In one example, a camera included in a computer device can be the capture device and images, or video captured from the compute device of a physical object can show the object at a time and location. In the event that the image or footage is disputed, metadata that can include location, date and time and comparing weather visible in the image or footage to reported weather conditions to add verification to the metadata. In one example, data associated with a worker, such as a vehicle, license plate, of other indicia can be captured by the computer device and capture device. For example, if a license plate can be captured, the license plate information can be compared with public data and the attendance of the worker at a location or physical object can be verified.

The metadata that is captured can be dependent upon the device and can include metadata associated with a worker, equipment, weather, enterprise software, security hardware and software, material, indicia, smart contracts, public records, authentication information, date, time, location, entity, and any combination of these examples. The biometric data may include facial recognition, an iris/retinal scan, a fingerprint scan, a hand scan, a voice print, or heart rate signature and any combination.

In one embodiment, an image or video captured can be used to identify an approximate object, event, time, location, and other data. The computer device can capture data in response to an event associated with the physical object. For example, if the physical object changes location, is modified, transferred, integrated, or other action, process or procedure associated with the physical object can signify an event.

A location can include a manufacturing place, construction site, business providing services, origination site, delivery site, event site, or other location where an object or materials will be used including the creation, collection, maintenance, repair, use, or integration of the object or material.

Verification, including verification of an event, can include verifying that the physical object and the digital representation match and can be accomplished in a variation of methods including interaction with identification elements such as a sticker, tag, label, physical features and the like, capturing an image of the object or event, capturing a video of the object or event, capturing indicia such as a tag physically affixed or otherwise associated with the material, human visual inspection, and any combination. Identification of an individual performing or otherwise associated with an event can be captured by identification devices (e.g., cards, tags, RF ID) and biometrics including visual capture (e.g., facial recognition), voice recognition, iris scan, fingerprint, palm print, weight, dimensions, change in weight, dimensions or other attributes, and any combination. Examples of verification processes can include having stored data about the physical object and comparing the physical object with the date, using machine learning process video, using imagery, audio clips and other media to and any combination. Individual human inspectors can be used to verify physical objects and events onsite and offsite. Individuals can process video, imagery, audio clips and other media to verify assets and events and provide the verification to the system at one or more events. Upon verification of an event, smart contracts can be executed according to verification of the physical object and event.

The first computer device can also capture object data associated with the physical object. Object data can include an image of the physical object, tag, label, RFID, weight, dimensions, and other indicia and any combination thereof. The object data can be captured at a first event that can include a change in state of the physical object, change in location change in time or any combination thereof. When an event occurs, which can be a second event, a second computer device can have a second capture device metadata originating from the data device that can be included in the second record. The second computer device can also capture object data associated with the physical object at the second event.

The first capture device metadata and object data can be used to create the first record which can be a first event record. The first event record can be stored on the immutable storage. The second capture device metadata and object data captured by the second computer device can be used to create the second record which can be a second event record. The second event record can be stored on the immutable storage. Immutable storage can be a storage medium or system where the data or object being stored cannot be changed or modified after its storage.

During data capture by the first computer device, object indicia can be capture where the object indicia is associated with the object. The object indicia can include a still image of the object, a label affixed to the object, a radio frequency identification (RFID) tag, an ultra-high frequency (UHF) tag, a bar code, a QR code, a Bluetooth beacons, alpha-numeric characters, and any combination thereof. The object indicia can be included in the first event record and stored on the immutable storage. When a change in time, location or other event occurs the second computer device can capture the object indicia. Once captured, the object indicia can be compared to the object indicia in the first event record and if the two matches, then verification exists that the physical object associated with the second event is the same physical object that was present at the first event. In one embodiment, the second capture device can capture data, transmit the data to the computer system 102 and computer readable instructions on the computer system can perform the comparison of the object indicia capture as the second event with the object indicia included in the first event record.

Computer readable instructions on the computer device can capture the user information, object information and event information. The user can include the username and password. In one embodiment, the user can be associated with a digital storage such as a digital wallet. The user information that is received can be used for verification of the identity of the user. The user can provide biometric information that can be compared to a local or remote database of identification information and the user using the computer device verified. The object information can be captured and can include metadata related to the object including file types, creation dates, file attributes (e.g., format, compression, protocol, and the like), names, headings, and other data about the object and object information. The object information and the event information, along with its metadata can be compared metadata such as location and time to verify that the object information and the event information are authentic. The system can create a capture record which can be information about the capture of the object and event information and the capture record can be stored on the immutable storage system. Therefore, the capture record can be subsequently retrieved and compared with the original or subsequent object and event information for validation. The object information and the capture information can include an unique identifier associated with the object or event.

The system can retrieve a first capture record and a second capture record and compare the respective records to determine of the physical object is the same physical object at the first event and the second event. If the capture record does not include consistent information, a notification can be provided indicating that the physical object has been changed, modified or otherwise different between the first event and the second event.

In one embodiment, a first computer device can capture user information, object information and event information, create a first capture record, and store the first capture record on the immutable storage system. A second computer device can retrieve the first capture record from the immutable storage and compare object information captured by the second computer device with the first capture record and first object information to validate the digital representation of the physical object. The first computer device and the second computer device can be the same device.

The system can therefore pair the physical object with a digital representation, such as a unique identifier, and verify among objects and events that physical object has not been improperly changed. This system can provide for verifications at each event that the physical object has not been replaced, modified, or otherwise changes. An event record created with this process can have a verification code associated with is so that validity of the event record can be determined.

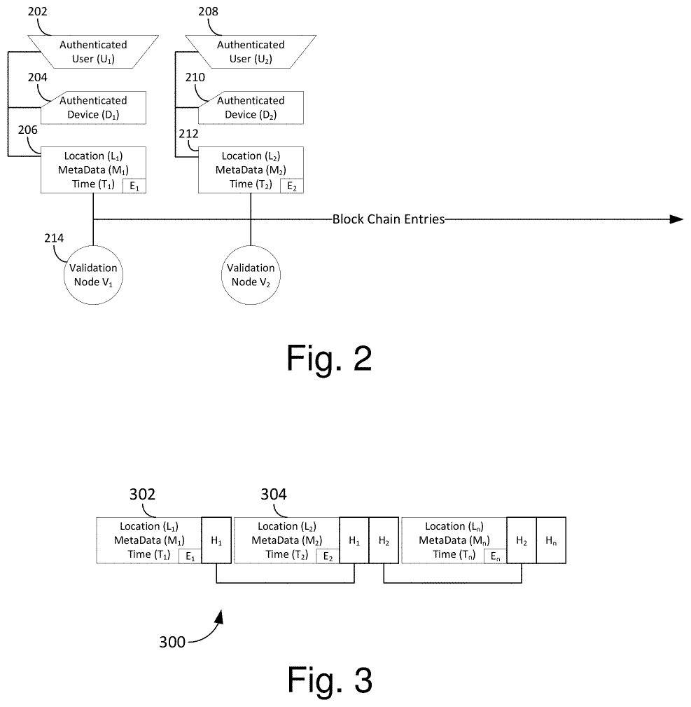

Referring to FIG. 2, one embodiment the user of a computer device can be verified at 202 so that the user can be authorized to use the computer device or to perform data capture at the first event. The computer device can be authenticated at 204 representing the computer device is the correct computer device and is in working order. The metadata that can be captured by the computer device can include a location, a time and additional metadata shown as 206. The user can be a first user and in one embodiment a second user of a computer device can be verified at 208 so that the user can be authorized to use the computer device or to perform data capture at the first event. A second computer device can be authenticated at 210 representing the computer device is the correct computer device and is in working order. The metadata that can be captured by the computer device can include a location, a time and additional metadata shown as 212. In one embodiment, the first event record and the second event record can be committed to immutable storage such as blockchain using validation nodes included in the immutable storage structure. A validation 214 can be created and stored. The event record E₁, which can be represented by data taken from U₁, D₁, L₁, M₁, T₁, or other data, can have a validation code V₁. When the even record is retrieved, a second validation code V₁ₐ can be determined and compared with V₁. If these validation codes match or are within an acceptable range, validity of the data from storage to retrieval can be determined.

Referring to FIG. 3, in one embodiment the second event record 304 can be linked to the first event record 302 to create a digital audit trail 300 that includes object indicia verifying that the physical object remains the same physical object throughout a process or where the physical object was modified, changed or otherwise different during the process. A validation record can be created for the first event, the second event, the first plus second event and any combination including the inclusion of n additional records. The system can also record changes in the event or object including changes in the locations, time biometrics of an associated individual, thereby providing an audit trail of the changes.

One example of the invention can include when a material is selected for transport by the supplier, a shipping company can be sent a shipping order representing the material to be transported, an origin and destination. The shipping order can be provided directly to the shipping company or can be retrieved from the immutable storage. Once the shipping company receives the shipping order, it can travel to the origin and receive the material which can represent a first event, and capture data associated with the first event. A first event record can be created representing that the shipping company received the materials and pair the received material with object indicia. In one embodiment, verification that the material is associated with the object indicia can be performed by an individual receiving the material.

Once that material is delivered to the destination, the shipping company can unload the material, a second event, a second verification can occur verify that the material that was delivered to the destination was the same material received at the origin. A second event record can be created representing that the material was delivered and that the material matches the material at the origin and described on the shipping order. The second event record can include the environmental conditions when the material was delivered, delivery notes and the like. The destination can be a receiving entity that can create a third event record representing that the material ordered was received. The receiving entity can use a third computer device to capture the object indicia and create a third event record. The computer system second computer device and third capture device can verify that the delivered material matches the ordered material, and that the material has not been modified, changed, substituted, or otherwise different from the origin to the destination.

The receiving entity can use a computer device that can include biometrics or other indicia to verify that workers using the material are authorized and have the necessary licenses, work certifications, experience, authorizations as well as for verified payroll and insurance coverage. The verification can be through biometric identification devices such as a camera or other image capture device, facial recognition, voice recognition, retinal scans, fingerprint scanners, hand scanners, and other biometric devices. In one embodiment, the computing logic may allow authorized individuals to manually enter the presence of another authorized individual, including on the controller at the project location or through a remote device that can be determined to be at the project location, within a boundary associated with the project location, in proximity to the system. In one embodiment, individuals may be verified and paired with a digital representation using two-factor authentication.

The receiving entity can be uniquely associated with a location. A location marker can be affixed at the receiving entity and uniquely identify the receiving entity and in one embodiment, a project location. The location marker can be read by a computer device and provided to the computer system and the immutable storage. In one embodiment, the receiving entity can receive metadata such as a shipping identifier associated with the delivery, including a truck, trailer, pallet, or other container so that the materials are known to be received at the project location.

In another example, the system can be used for the recording, authenticating and validation of objects and events such as sporting events and the objects that may be assisted with such an event. For example, a sports fan can obtain an object (e.g., catch the xxxth homerun ball) as the event. The system can be used to record the object (e.g., ball), the date, time, location, and the sports fan. A unique identifier can be created or capture that is associated with the object, such as a tag or label. And digitally record with the associated metadata. The event (e.g., sports game) can also be captured including a image or video of the event, date, time, location and sports fan. This information can also be recorded. A capture record can be created including the user information, object information, event information and any combination can be recorded on the immutable ledger. A identifier, such as a barcode or QR code, can be created or captured and associated with the capture record so that when the identifier is capture (e.g., scanned or imaged), the capture record can be retrieved and the digital representation of the physical object or event can be verified by compression of the data in the capture record with the p[physical object or event.

The computer system can be contained in a housing such as a kiosk and can be physically associated with a project location. The project location can be defined by a boundary representing the perimeter of the physical location. The system can include a sensor and reader which can be selected from the group consisting of radio frequency identification (RFID) detector, ultra-high frequency (UHF) detector, a bar code scanner, a QR code scanner, near frequency communication (NFC) device; Bluetooth beacons, an optical character recognition (OCR) device and any combination thereof. An environmental sensor, such as a weather sensor or weather station, can be in communications with the or included in the housing and configured to record the weather and other environmental conditions at the location and at different times during the project. If the environmental sensor detects a change in the environmental condition, it can represent an event.

The system may record the date and time of events such as the arrival and departure of materials, individuals, workers, supplies, third parties, inspections, and the like to and from the project location, the date and time associated with environmental conditions including weather. The environmental conditions can be used to modify the schedule for workers so that workers are not working during inclement weather, tasks are not preformed outside specified environmental conditions, and materials are delivered and installed during specified environmental conditions.

The system may track the movement of material at a project location or during a process or to and from the project location thereby creating an audit trail associated with the material. Scanning technology such as RFID readers, UHF readers and/or the like may be utilized to assist the location tracking for tools, equipment, materials and even workers. The tracking the material assists with reducing the risk of loss, theft, mis-delivery, and the like. For example, the tracking solution may indicate instances of possible theft, such as when the materials are leaving the project location when the removal of the materials is not proper.

The system may allow for the establishment of one or more geofenced zone that can be associated with delivery areas, worker entrance exit areas, task areas, storage areas, assembly areas, distribution areas and any combination thereof. These areas could be monitored and established with access allowances or restrictions to control movement of material, individuals and equipment to assist with the prevention of loss, mistakes, inefficiencies, and damage. The system can assist with verification that materials stored-on locations are consistent with specifications associated with the materials. A first event can be the material being deposited at a location in a first zone and a second event can be the material being deposited at a second zone. The first event can be associated with the object at a first zone and a second event can be associated with the object in the same zone, at a later time.

The system can also use smart contracts associated with events and stored on the immutable storage that can be self-executing upon satisfaction and verification of contractual terms and objects associated with an event. For example, when an object is delivered from a shipper to the receiving entity and the receiving entity verifies that the object was properly delivered, a smart contact that instigates payment to the shipper can be performed.

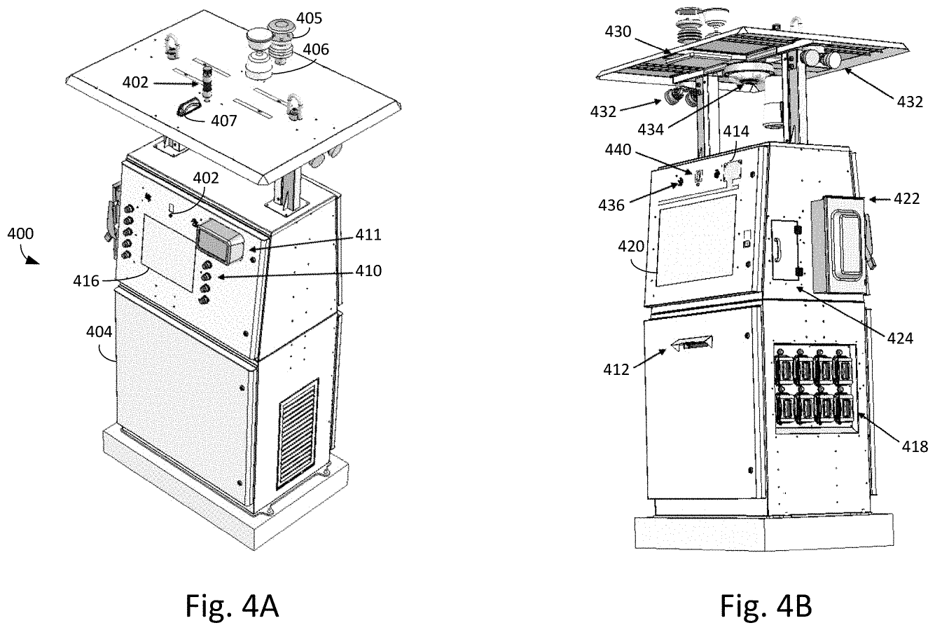

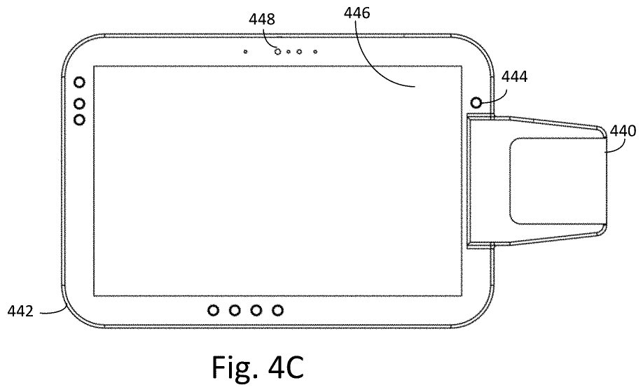

Referring to FIGS. 4A and 4B, in one embodiment the computer system can be contained in a housing 404 can be physically associated with the project location, virtually associated with the project location or both. The housing can be a kiosk in one embodiment. A unique location marker can be disposed at the project location to uniquely identify the project location. For examples, a transmitter such as a RFID can be associated with the project location by embedding it is a permanent fixture such as a concrete slab, foundation, structure, and the like. The system can read the information from the location marker and associate its actual location with the project location. The location marker can include an alpha, numeric, or graphical information such as a number, letters, barcodes, QR code, physical or geographic coordinates (e.g., GPS coordinates), passive transmitter, active transmitter and the like. Each system can have a unique identifier and each project location can have a unique identifier.

A first side of the system can include a camera 402 for obtaining images of materials, equipment, individuals, or other items entering or leaving the project location as well as images of individuals along a perimeter. The camera 402 may capture biometric images upon which biometric recognition may be performed. Multiple cameras may be placed on or around the housing. The cameras may have biometric recognition and motion detection capabilities. System 400 may include one or more cameras 402 that can be used as biometric-based identification devices to confirm the identity of individuals entering, leaving or on the perimeter of the project location. The system 400 may include an antenna 406 for communicating with a network including a wireless network, Wi-Fi network, Bluetooth, quantum networks, cellular network (e.g., 4G or 5G network) and any combination. The system 400 may include a housing 404 made of suitable weather resistant material, appropriately sealed to protect the internal hardware. The system 400 may include a display 416, such as a touchscreen display, upon which information may be displayed and entered. The display 416 may include an integrated camera that may be used to capture images and that may be used in performing facial recognition of individuals. The display may also include or operatively associate with one or more integrated speakers for providing audio output, a microphone for receiving audio information to facilitate two-way communications to a remote location. The system 400 may include a scanner 412 for scanning items, such as deliveries, as will be explained in more detail below. The scanner 412 may be, for example, a QR scanner, barcode scanner, an Optical Character Recognition (OCR) or another scanner 411 in some instances. Actuators such as button 410 can be carried by the housing and connected to a controller, computer medium, computer of other information processing device. One side of the system 400 can be used for deliveries and inspections. A delivery person may scan delivered materials, equipment, or other items via the scanner 411 or 412 and may interface with the system using the touch screen display 416. An inspector may scan or take images of inspection documents via the scanner 411 or 412 or camera and may interface with the system using the touch screen display 416. In some embodiments, there may be fewer sides in which to interact with the system for all authorized personnel. An overhang may be provided to assist in decreasing glare and protecting some of the items on the housing from the weather.

Another side can include a touch screen display as well as a scanner 412. Display 416 may include or be operatively associated with an integrated camera for capturing images, speakers for providing audio output and a microphone to facilitate two-way communications with a remote location. Still further, this side of the system may include data ports. The system may be accessed to gain access to equipment, tools and to sign in or sign out when leaving or entering the project location, as will be described below.

Another side of the system can include a location 420 where information such as permits, specifications, instructions, tax information, plans, and the like and may be displayed. In some embodiments, the information displayed may assume electronic form so that a video display is provided in the housing. A tax map submap (TMS) number for the project location may be displayed on the housing. Other location identifying information can be displayed such as location number, store number, assembly number, area within the project location and the like. In addition, the site address may be displayed on the system. The site address may refer to both the mailing address for the project location and/or other physically identifying information associated with the location.

Another side of the system can include an access panel 422 may be provided to access a breaker box for the system. An additional access panel 424 may also be provided to access internal components of the system. Still further, access panel 424 may be provided to gain access to power source for providing power at the project location. The access panel 418 may be under programmatic control in some instances to regulate access to the power source. If access is granted, the panel is unlocked, whereas if access is denied, the access panel 418 is locked. In some embodiments, access to the power supply may be controlled by controlling the flow of power to the power source under programmatic control from the controller. These control mechanisms may be used separately or in conjunction.

Referring to FIGS. 4A and 4B, the housing 404 can include a worker side that is configured to be used by a worker at the project location. The housing can include an alarm indicator 407 that can be actuated as described herein. The housing can include a weather station 405 that can include an integrated or separate fluid (e.g., rain) collector. Biometric reader 414 can include an iris scanner, fingerprint scanner, palm print scanner, facial scanner, or some combination. Display 416 can be proximity to input assemblies such as buttons 410. The housing can include a field receiver 430, lights 432 and camera 434. One or more cameras can provide a 360° field of view and include a wireless connection for transmitting images to a remote computer device. The images can also be used for input to the system including input allowing the system to identify delivered materials. The system can include one or more second cameras 440 such as webcams disposed at various locations around the system for capturing images. The lights can include motion activation and photoelectric activation. Speakers 436 can be included to provide audio information to a user, worker, inspector, or other party using or near the system. The audio information can include instructions, alarms, and the like. Power junction can include a shut off switch that can be used in emergency and non-emergency situations. The system can include a secondary power source, such as a battery, so that when the main power is shut off, an alarm can sound, notification send to a remote computer device of other indication that the system or power source has been powered down. The system can include a hand scanner (not shown) that can be protected by a hand scanner access door. A document scanner 412 can be included in the system for receiving physical documents, converting the physical document into a digital representation, and storing the digital representation on the computer readable medium or the immutable storage. The system or housing can include electrical outlets 418 for providing power to various tools and equipment at the project location including recharging batteries. The system can include a wired connection to remote computer devices of a transceiver to provide a wireless connection to remote computer devices.

Referring to FIG. 4C, the computer device and the capture device can be mobile devices. In this example, the capture device 440 is attached to the computer device 442. The computer device can include a camera 444, display 446 and microphone 448 and speakers 450.

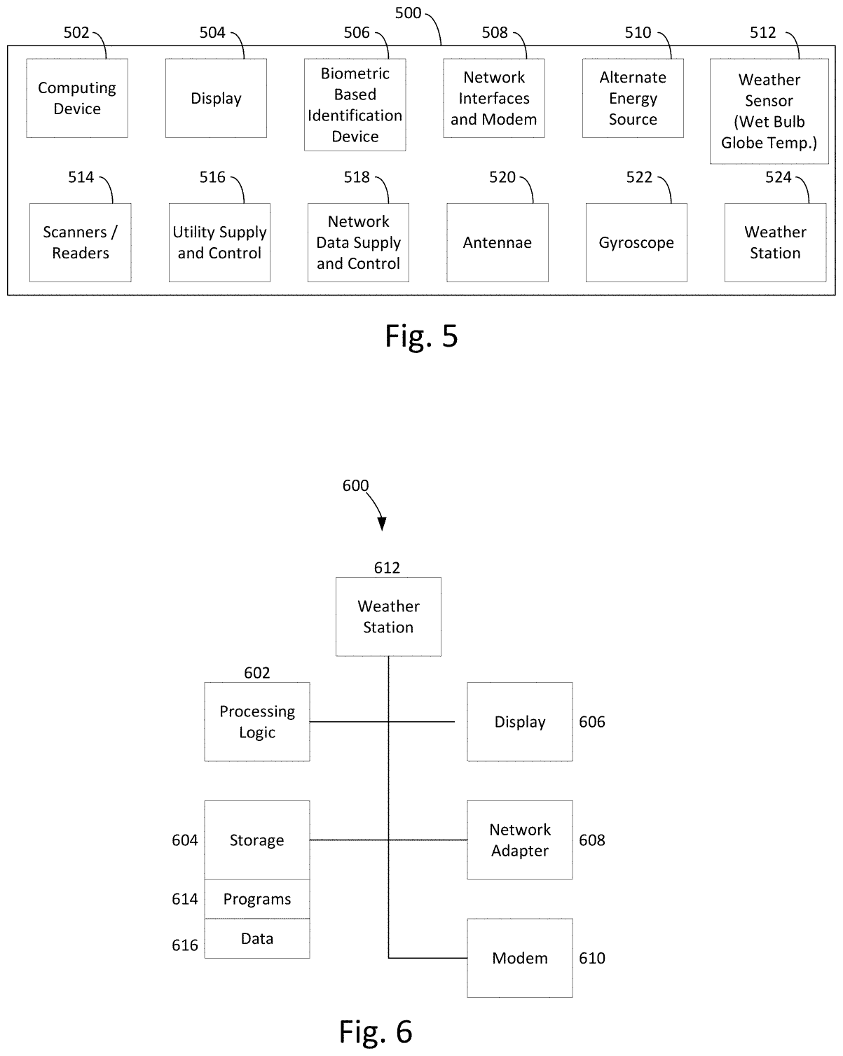

FIG. 5 depicts components that may be included in the system of exemplary embodiments even when not included in a housing. The system may include a computing device 502. The computing device 502 may take many different forms indicating a desktop computing device, a laptop computing device, a mobile computing device, an embedded system, a smartphone, special computer device, custom computer device, or the like. A display 504 may be integrated with the computing device 502 or as a separate device, such as a liquid crystal display (LCD) device, a light emitting diode (LED) display device or other types of display devices on which computer information may be displayed. One or more biometric-based identification devices 506 may be provided. As will be explained in more detail below, multiple biometric-based identification devices may be used. Network interfaces and a modem 508 may be provided. The network interfaces may interface the computing device 502 with a local area network or a wide area network wherein the networks may be wired or wireless. A modem may be provided to communicate telephonically or over cable lines with remote computing devices.

The system 500 may include various scanners and readers 514, such as those described above relative to housing. The system 500 may include a utility supply and control 516 and a mechanism for turning the utilities, such as power, gas and/or water, on and off under a programmatic control. The system 500 may include an internet data supply control 518 and a mechanism for turning the access to this service on and off under a programmatic control. Programmatic control may be provided to grant or deny access to such resources. The system 500 may include an antenna 520 for wireless communications signals to receive and transmit. The system 500 may include a gyroscope 522 to monitor any moving of the system. The gyroscope 522 may indicate motion indicative of whether someone is trying to move or tilt the housing or other component of the system. Logic may be provided to send a notification in such an event where the gyroscope indicates substantial enough movement. The system 500 may include a weather station 524 to measure current weather conditions, such as temperature, air movement, humidity, precipitation, barometric pressure, direct sunlight, and the like. Input from the weather station 524 may be used to inform decision making by the system in some instances. Alternatively, the weather may be collected via software, such as from a weather service or other weather source. Similarly, the system 500 may include a weather sensor 512. The sensor can be a wet bulb globe temperature adapted to measure, among other things, heat stress in direct sunlight, which accounts for temperature, humidity, air movement (direction and speed), sun angle and cloud cover (solar radiation).

FIG. 6 shows an example of a computing device 600 for the system. The computing system may include processing logic 602, such as microprocessors, controllers, field programmable gate arrays (FPGA), application specific integrated circuits (ASICs) electronic circuitry, and other types of logic. The processing logic performs the operations of the computing device 602. A storage device 604 may also be provided. The computer readable medium and/or data storage device 604 may take various forms, including magnetic storage, optical storage, etc. Storage capability 604 may include computer-readable media, including removable computer readable media, such as disks, thumb drives and the like, or disk drives, solid state memory, random access memory (RAM), read only memory (ROM) and other types of storage. The computing device may include a display 606, such as an LCD display, an LED display, or other types of display devices on which video information may be displayed. The computing device 600 may include a network adapter 608 for interfacing with networks and a modem 610 for communicating wirelessly, over telephone lines or cable lines with remote devices. The processing logic 602 may use information stored in the storage device 604. In particular, the processing logic 602 may execute programs 614 stored in the storage and may access and store data 616 relative to the storage device 604. The computational functionality of the system described herein may be realized by the processing logic 602 executing the programs 614.

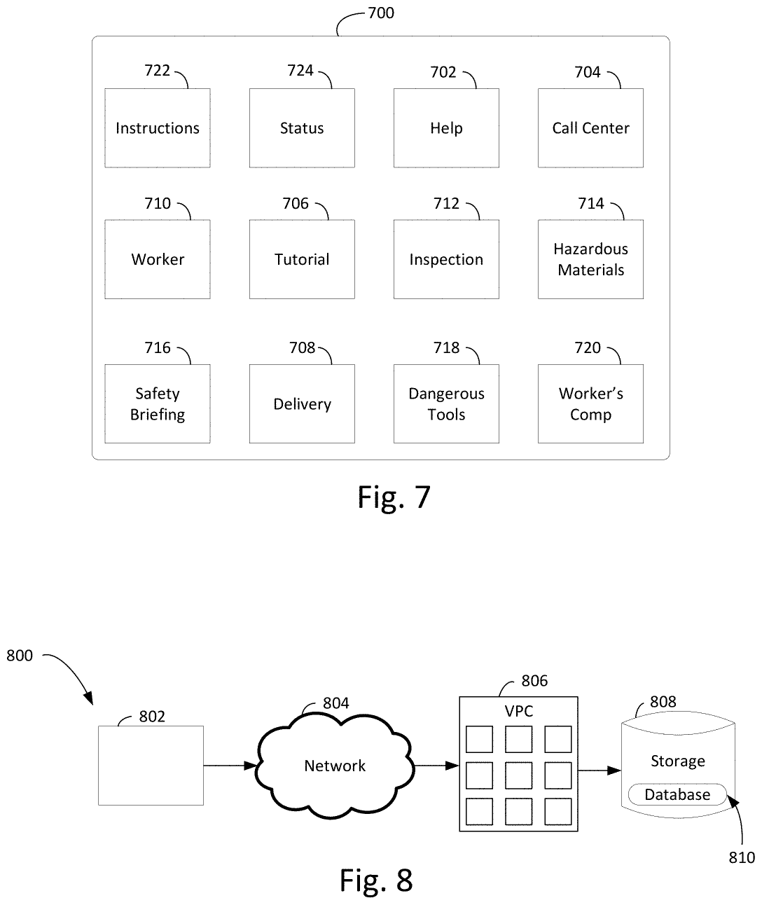

FIG. 7 shows an example of a user interface on one or more displays. The user interface may include activatable elements. A user may depress these activatable elements or select these activatable elements using an input device, such as a mouse, keyboard, touchscreen, or the like, to activate the components. The display may include a help element 702 that may be activated to obtain help information regarding use of the housing. It may also contain real time project or process plans. It may also include “how to” assistance including videos related to the various projects, stages, processes, and tasks performed at the project location. The user interface on a display may also include a call center activatable element 704. Selection of the call center activatable element 704 may cause a call to be initiated with a call center so that the individual using the system may have a telephone and or video conference with personnel at the call center. The user interface on the display may also include a tutorial activatable element 706. Selection of the tutorial activatable element causes a tutorial to be displayed to teach the individual about operation of the housing.

The system 700 may include software which allows each tool to be coded or assigned to authorized personnel. Each tool can have a verifiably paired digital representation associating the specific tool with the digital representation. This can be verified by the system through recognition of the tool from a reader or sensor. The tool supplier record can be created by the tool supplier and include a digital representation associated with the tool and store the digital representation paired with the tool on the immutable storage. When the tool arrives at the project locations, the system can retrieve the tool supplier record and determine of the tool requested if the actual tool that arrived. A tool verification record can be created and stored on the immutable storage representing that the tool delivered and received matches the tool supplier record. Shipping or delivery company personnel may activate the delivery activatable element. This causes a delivery functionality to be displayed where delivery notes may be added and where information may be gathered from the delivery person regarding a particular delivery.

An inspector activatable element 712, may be activated to cause the inspector functionality to be activated. The inspector functionality may enable an inspector to add inspection notes, provide electronic inspection certificates and the like. The system can provide reports that can be automatically generated from the existing data described herein as well as notes manually added during the construction process. The reports can be generated at predetermined times such as daily or upon completion of specific tasks.

As shown in FIG. 8, the exemplary embodiments may be implemented in a decentralized computing environment 800, that may include distributed systems and cloud computing. FIG. 8 shows one or more systems 802 that may be in communication with a remote cluster 806 via a network 804. The cluster 806 may store information received from the system 802 and provide added computational functionality. The network may be a wired network or a wireless network or a combination thereof. The network 804 may be a secure internet connection extending between the system 802 and the cluster 806, such as a virtual private cloud (VPC). The server may be a computing device and can be in communications with the site computer device. The cluster 806 may include access to storage 808. The storage 808 may include a database 810 in which information regarding a project location is stored in a consistent manner.

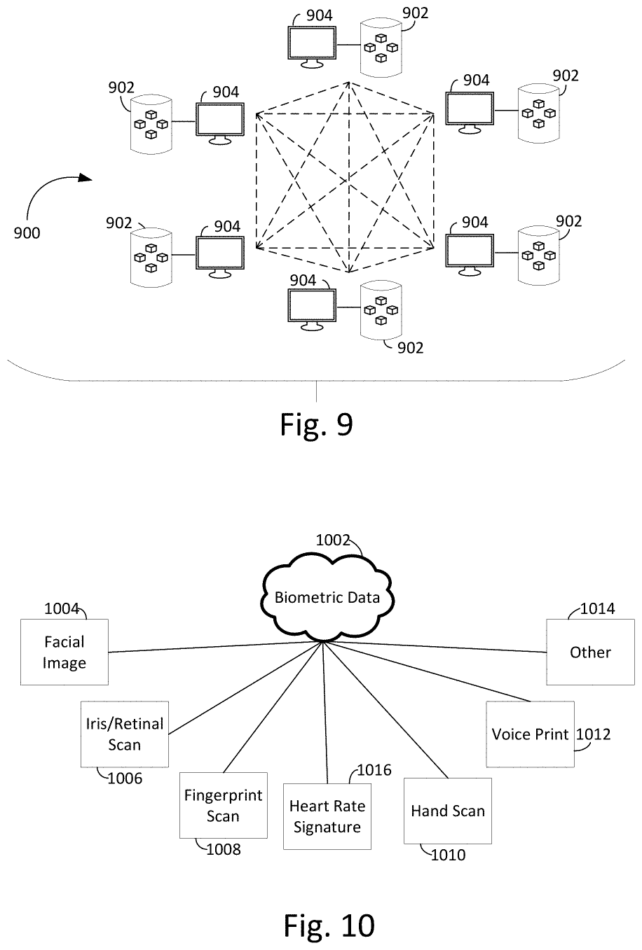

FIG. 9 shows diagram 900 of an example of a peer-based network where an immutable storage 902 is broadcast and shared among the nodes 904. This network may be resident in the VPC cluster 806 (FIG. 8) or in a network for example. The nodes 904 may represent computing resources, such as server computer systems or other computing systems, residents at the parties identified in FIG. 9, for example. Each node that has access to a copy of the immutable storage 902.

The various computer devices, including the server and site computer device (e.g., system, controller, and any combination), can be in communications with immutable storage. The immutable storage can include a distributed ledger, immutable database, block-chain structure, and the like. The communications between the various computer device, including the server and the site computer device and immutable storage can be a global communications network, wide area network, or local area network, delivered to a computer readable medium from one device to another (e.g., USB drive, CD, DVD) and can be wired or wireless.

Referring to FIG. 10, the of biometric data 1002 that may be obtained by biometric-based identification devices at the project location to attempt to identify individuals. Biometric data may include facial recognition 1004, an iris/retinal scan 1006, a fingerprint scan 1008, a hand scan 1010, a voice print 1012 or heart rate signature 1016 or other input or sensor 1014. It should be noted that other types of biometric data may also be used in exemplary embodiments to help identify individuals uniquely. Also, an individual may be required to provide multiple types of biometric data in some instances.

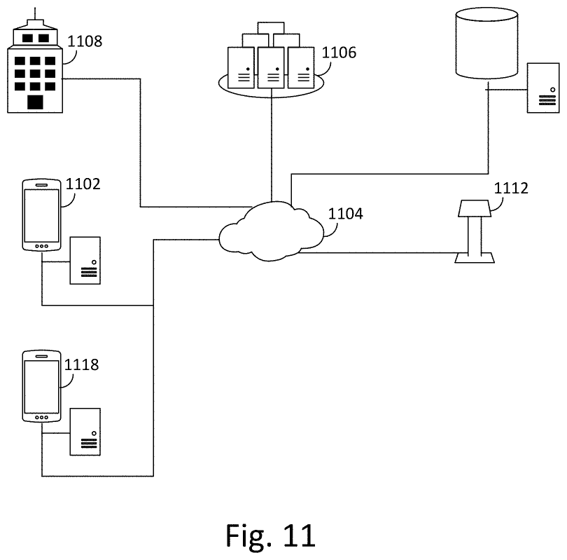

To help illustrate an example of geofencing, FIG. 11A shows an illustrative project location 1100. The project location 1100 may include a housing 1102 for the system as well as storage location 1104 that can be a building, trailer, shed or the like. The storage location 1104 may hold tools, equipment, wearables and/or materials. The project location 1100 may also include a task location 1106. The task location may be where tasks are performed using materials to produce a good or offer a service.

FIG. 11B shows an example of different areas that may be established for geofencing at the project location 1100. Area A shown a boundary 1108 may include the entirety of the project that is under construction. Area B 1110 may be a portion of the project, such as the kitchen. Another area may be a shed and another area may be the entire project location. Individuals may have access to none of these areas or to a subset of these areas, including all areas.

Referring to FIG. 11, computer device 1102 can be in communications with a network 1104 and immutable storage system 1106. The computer device can include ca capture device that can be included in the computer device, connected to the computer device or is communications with the computer device. The computer device can obtain information from other sources 1108 such as third-party time and date information (e.g., atomic and nuclear clock operators, weather information). The computer device 1110 can be mobile 1102 of stationary 1112 so that the computer device can be disposed at a user, object, or event location. Once user information, object information, event information, capture information is stored, another mobile computer device 1114 or other computer device 1116 can retrieve the stored information. The information can include a identifier that can be a physical identifier or digital identifier such as a QR code that can be affixed to the object or associated with an event. When the identifier is scanned, the various information and records can be retrieved. The system can include verification of an object and event with its digital representation with a subsequent computer device 1118.

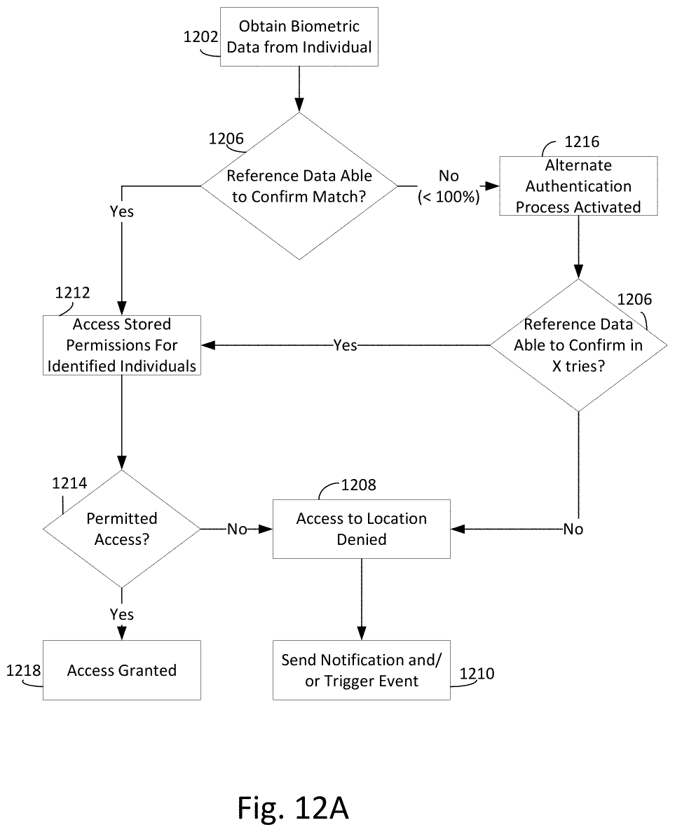

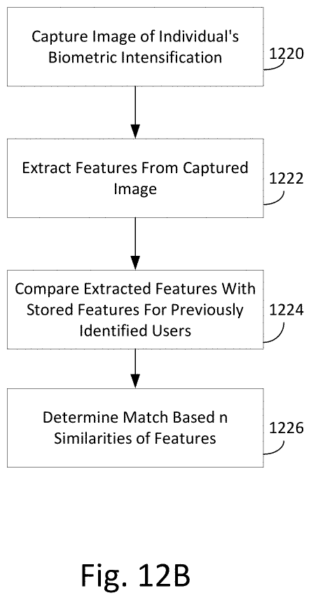

Referring to FIG. 12A, when a user wishes to use a computer device, the computer device and capture device can obtain biometric information from the user as 1202. A determination can be made at 1206 if the information from the user can be verified. If not, an alternative authentication process can be used at 1216. If the alternative method for user authentication is used, the system can determine if a predetermined number of tries are attempted at 1206 and if so, deny access at 1208 or retrieve the permissions for the users at 1212. IF the user is permitted access at 1214, access is granted at 1418, otherwise a notification that the user attempted to access the system can be created at 1410.

Referring to FIG. 12B, the image of the user can be captured at 1220. Features can be extracted from the captured image at 1222. The comparison 1224 can results as used to determine if there are similarities and to determine if there is a match at 1226.

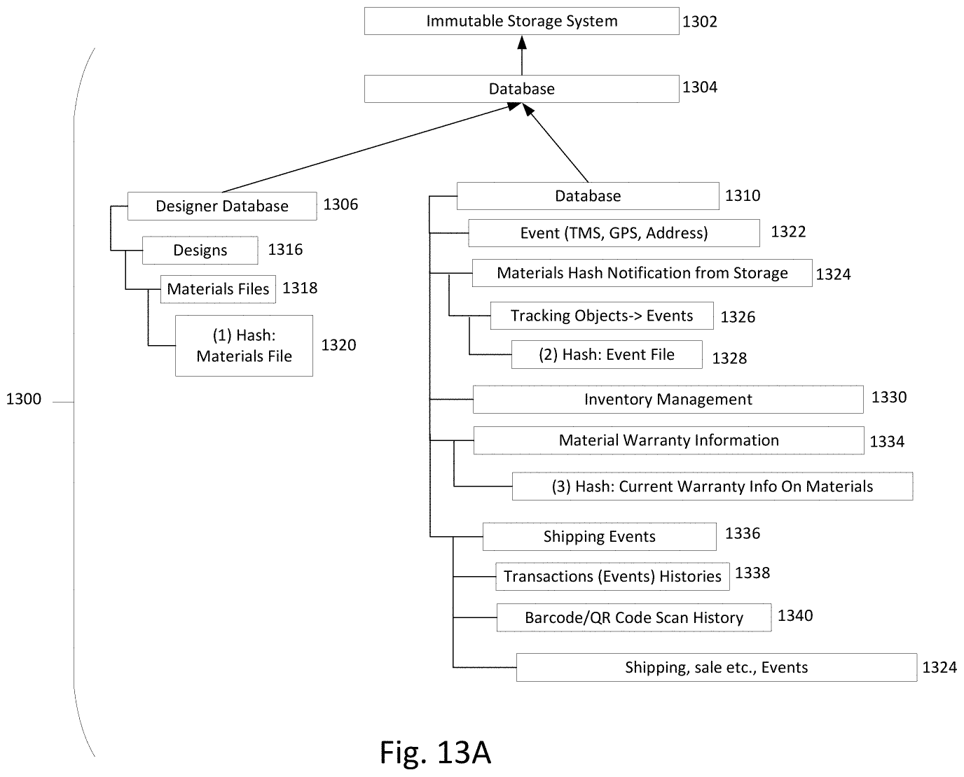

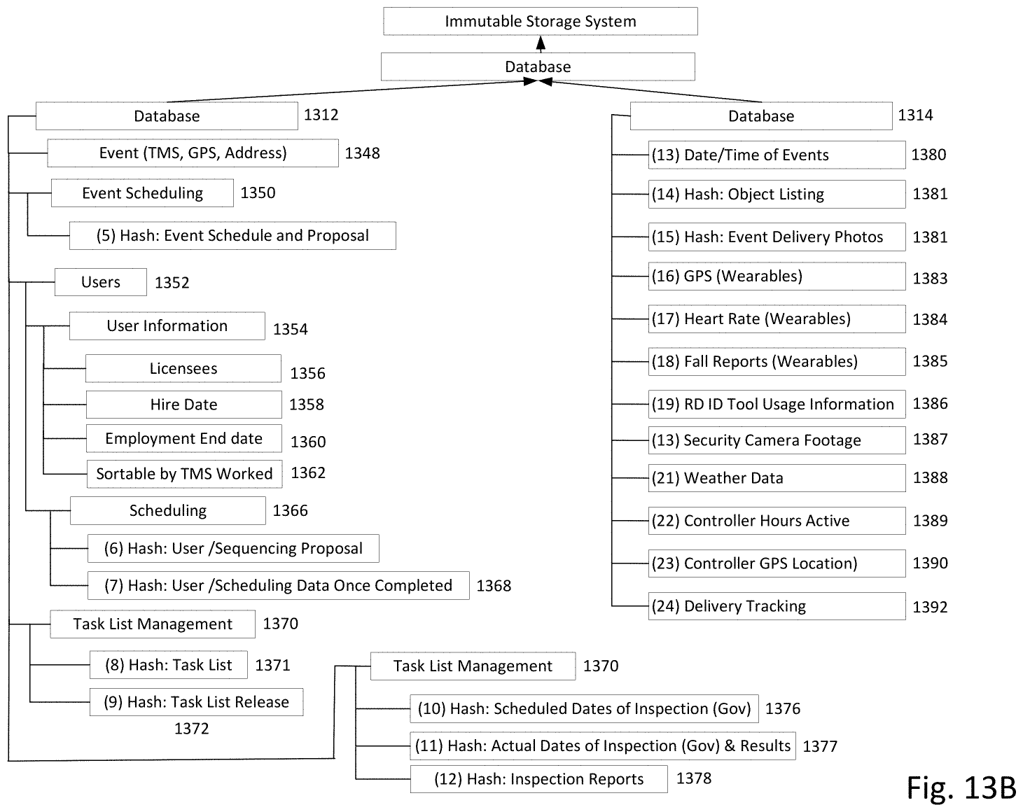

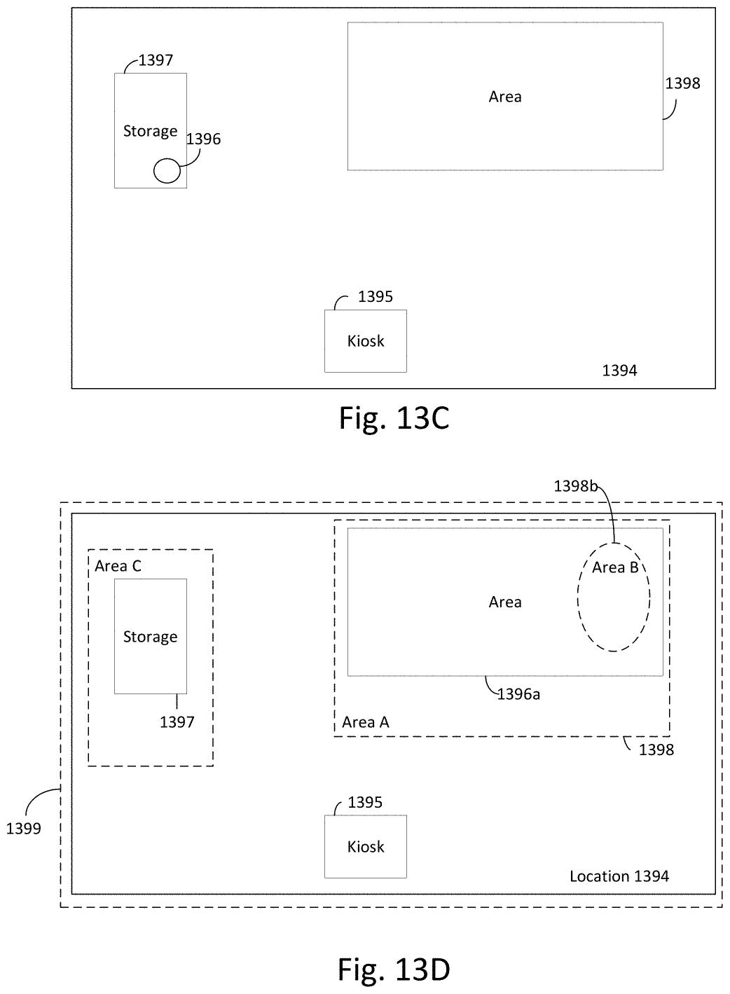

FIGS. 13A and 13B an example of the system in user is shown as it applies to an event where objects can be associated. A database of objects (e.g., sporting equipment, restaurant meals, supplies, and any physical object) is shown as 1310. The database may hold event information 1322, such as GPS data and addresses, times, attendees, event type, and other project or process properties. The database 1310 may store an object requirement record hash notification 1324 from the immutable storage 1302, indicating that the hash value for the object or event information has been referenced on the immutable storage 1302. Information 1326 tracking the object information or record may be stored in the database. The supply company may analyze and process the design to develop the object or event for the project or process. A hash value 1328 resulting from passing the design information through a secure hash function is stored in the database 1310, transferred to the database 1304 and referenced on the immutable storage 1302.

The database 1310 may also store inventory management information 1330, such as quantity and the particulars of material inventory and material warranty information for such materials. The warranty information for materials may be hashed into a value 1334 and the resulting hash value may be stored in storage in the database 1310. The hashed value 1334 may be passed to the database 1304 and then referenced on the immutable storage 1302. The database 1310 may also store shipping or storage information 1336. This may include bill of lading histories 1338 and barcode, RFID values, UHF values and/or QR code scan histories 1340. The material list (such as a bills of lading) for an assembly project and the barcode/QR scan codes for delivered items for the projects may be hashed and the resulting hash value(s) passed to the database 1304 for reference on the immutable storage 1302. Further, confirmation of what was specified by designers was delivered to the event or object location and stored or used according to specifications so that a project or process can be placed under warranty or other follow-on benefit.

A database may store object or event information, such as TMS #'s, GPS data, event activity, users, locations and the like. The database may also hold scheduling information 1348 for the object or event. This may include detail regarding event activities (e.g., workflow and timing). A hash value of the event 1350 may be stored on the database, passed to database 1304 and referenced on the immutable storage 1302. The database may store user information 1352. The user information 1352 may include identification information 1354 for users involved in events or with objects (e.g., storage, security, inventory, user). This user information 1354 may include information regarding licenses for user 1356, hire dates for users 1358, employment end dates for users 1360 and other information, such as names, photos, etc. The user information can include information that the user is in compliance with applicable laws (including federal and state), in compliance with contractual obligations, properly licensed, of legal status, of sufficient experience, within application restrictions such as a limit on hours worked during a 24-hour period, authorized for the event and its location and any combination. The user information may be sortable by tokens or keys such as TMS # to identify participants for an event. The database 1312 may also store scheduling information for users. This information may be used to develop a sequencing proposal that is hashed 1366 and the resulting hash value stored in the database 1312. The hash value 1366 may be passed to the database 1304 and referenced on the immutable storage 1302. User and event sequencing data once a task or event is completed, the information may be hashed, and the resulting hash value stored in the database 1312 for a project. This hash value 1368 may be passed to the database 1304 and referenced on the immutable storage 1302.

Task information 1370 may also be stored in the database 1312. The task information 1370 may include a hash of the tasks for an event and a hash of tasks releases for an event 1372. These hash values 1371 and 1372 may be passed to the database 1304 and referenced on the immutable storage 1302. The task information can be used for a determination of warranty requirement compliance for the event, object, user and associated information.

The captured information can be accomplished using various scanning and reader technology. A machine vision system may be provided. The machine vision system may capture an image of objects and events and process the image to determine the nature of the objects as well as the quantity. Moreover, the machine vision system may capture an archival image that may be indicative of the state of the objects at any given time. A QR code scanner may be used where QR codes are on an object. Similarly, a bar code scanner may be used where bar codes are on the items or on documentation delivered with the items. Still further, an RFID reader may be provided to gather information regarding the delivered items.

In one embodiment, a user can be an inspector or other official that can interface with the system and preform steps that may be performed in such an interaction. Initially, the identity of the inspector may be confirmed using the biometric data or manually using the touchscreen on the system. The inspector then performs the inspection of the appropriate portion of the project location. The inspector then accesses the system, such as through the system at. The inspector then may record notes and/or post certificates or notices at the system. Additionally, the inspector may use technology available via the system such as OCR scanner or the like to capture appropriate information the inspector may have written during fulfillment of the reason for being on the site.

Systems at adjacent locations may be used in conjunction with each other. For example, in the event that there are multiple smart indicia on one or more physical objects, the proximity of the indicium to each other can be used to verify the status, disposition and location of the one or more physical objects. In one indicium moves a certain distance from another, it can indicate a change in status that can be associated with an event record and the physical object.

The steps that may be performed by image capture devices, such as still cameras or video cameras, from multiple adjacently situated systems can be used in conjunction. Video feeds or still images may be obtained from the image capture devices from multiple systems. The video feeds or images may then be processed, such as by the cluster described above, using software such as motion detection software, thermal image analysis or other image analysis software to identify activity that may warrant a response. When a motion is detected, it can trigger data capture for that event.

As has been mentioned above, a great deal of information may be collected and stored about an object and event during or after an event. The information obtained during the project from many different sources may be stored on or referenced from immutable storage. The information may be stored on an ongoing fashion, in databases as described below, and may be referenced in an immutable fashion on the storage. This information may help resolve disputes between parties involved with objects or events. For example, suppose a buyer asserts that the wrong objects were delivered. Since there is a complete record references on the immutable storage of all events, these records may be accessed to resolve the dispute. Disputes regarding pay among workers may be resolved by checking the recorded hours on a location to determine the appropriate pay for the workers. Inspection records may be accessed to confirm that proper inspections were carried out and passed.

The information referenced in the immutable storage may also be accessed from a computing device of an owner, end user, customer, integrated and the like at. The computing device may be, for example, part of a home maintenance system that manages and controls home systems, such as heating, air conditioning, lighting, an alarm system, or the like. The computing device may be part of a smart home controller and may interface with appliances and other items that are interconnected via a home control network. The computing device may include a document management system for securely storing the transferred information. The computing device may be a facilities management system, or operations system associated with the project location.

Items may be affixed, such as barcodes, QR codes, RFID identification, Bluetooth beacons and/or UHF identification when the items arrive at the supply company. Stickers may be affixed to the items to associate the codes with the items. The items in each package may be scanned to record what items are included in the packages. The packages may be wrapped as needed and a QR code sticker may be affixed to the outside of each package. The QR code for each package is scanned. The process may then generate a material list for each delivery.

Interactions relating to a smart contract for the project or process can be implemented using the system. For example, suppose that the supply company makes a delivery to the project location. Further suppose that the delivery is confirmed by information such as that gathered by the system as discussed above. The lender then releases payment to the supply company. Payments can be made through third party funding, factoring, credit lines, loans, or other financial option to assist with financing and cash flow management.

The payment may be made electronically, such as through crypto currencies, like Bitcoin or Ether, or via a stable coin whose value is pinned to an item like a paper currency or the like. A cryptocurrency is a digital currency built with cryptographic protocols that make transactions secure and difficult to forge. Other Suitable forms of electronic payment includes Automated Clearing House (ACH) payment, Electronic Funds Transfer (EFT), card payments, other types of bank transfers or other types of electronic wallet transfer. In the case where crypto-currency is used, the crypto-currency may be delivered to the digital wallet of the supply company at a specified wallet address or account. The ledger may be updated to show that the contract is complete. Payment requires that the lender has sufficient funding in their digital wallet. If not, the smart contract will not be written on the immutable storage. If there is sufficient funding, payment is made, and the contract is written onto the persistence storage as complete at 3320.

There can be a relationship between the smart contracts and the project, process, or event. Initially, a schedule can be received. For example, the assembler can create the project schedule based in part on the design and material requirement record. Based on the project schedule, smart contracts may be constructed that use the immutable storage for contractual arrangements associated with the project or process. The smart contracts are implemented in software and in this case are used to provide electronic payments to parties for activities relating to the project or process using, for example, electronic payments, crypto currencies, fiat currencies and other forms of payments. The smart contracts may specify the conditions required for payment and may specify the amounts of payment. Smart contracts may also play a role with deliveries. Delivery and/or materials information is obtained regarding delivery to the project location for the project or process. The information obtained can include if the materials delivered match the material requirement record, manufacturer, and/or supplier which can be confirmed by multiple parties.

The delivery information is hashed, and the resulting hash value is referenced on the blockchain-based immutable storage. A smart contract is provided that uses the immutable storage. A determination is made whether the conditions specified in the smart contract are satisfied. If the conditions are satisfied, electronic payment for the delivery is realized. If the conditions are not satisfied, notice of outstanding issues are sent and the delivery worker may attempt to remedy the issues. The process may then repeat beginning with step until the conditions are satisfied.

To pair a material with its digital representation the system captures events at various points of transition of the material. Pairing the physical material with the digital representation can include several elements or components. Included in the pairing process can be the physical observation of the physical material and then associate the physical material with a digital representation so that the physical material is properly associated with the digital representation. This verification provides trust that the digital representation is accurately associated with the physical material as a factor rather than simply trusting that the digital representation is accurate. This system can use manual or automated processes to physically observe the material and associate the material with the digital representation during various events from raw material to final deliverables. Verification can also use the metadata that is associated with the interaction of physical items by individuals and electronics when the item is created, transported, installed, activated, and destroyed. The metadata that can be captured and placed into immutable storage can provide stakeholders an audit trail of history for their physical asset using a verified paired digital representation. A similar process as described herein can be used for pairing a biometric identifier with an individual.

For example, when raw material is harvested, a harvesting record can be created that captures the harvesting event and can include metadata concerning the event and verification that the raw material is associated with the harvesting record. For example, a digital image of the raw material can be captured, and the images and its metadata of the image captured can be included in the digital representation. The capture device and its metadata can also be captured and included in the harvesting record. For example, a sensor having a GPS transponder, camera and transceiver can be used to capture the harvesting event. The metadata of the harvesting event can include date, time, location (e.g., GPS coordinates), harvesting image, harvesting entity, harvesting worker, harvesting equipment and any combination. Once harvested, raw material can be loaded on a transport (e.g., vehicle, plane, ship, and the like). By capturing the harvesting event and verifying that the raw material and the digital representation are paired, and stored on the immutable storage, the physical material and the digital representation are paired allowing for reliance upon the digital record to accurately represent the physical material.

In one embodiment, the verification of the physical object can be performed using the weight or dimensions of the physical object captured throughout a process. The weight and dimensions can be combined with one or more images of the physical object where the capture device can be a scale, scanner, or other device. The capture device can be a combination of a camera and scale to provide for data streams during the process and at and between events.

By verifiably pairing the physical asset with a virtual presentation, the risk of unintentional or impermissible rehypothecation can be reduced or eliminated. The paired asset can be verified by multiparty chronological metadata streams that can be associated with a physical location. Because verifications using these streams are chronological, altering the information could require alteration of the metadata prior to and after the altered record. Therefore, the altered record would be inconsistent with the associated records potentially both temporally and geographically and an attempt to alter the record would be discovered. The use of an immutable storage further reduces the risk of alterations of records as well as increasing the verification of information. Further, pairing assets associated with the event, involving the asset, interactions with the asset and the associated metadata provide for a substantiated digital asset, reduce, or eliminate risk and improve capital efficiency. Further, the pairing of assets facilitates commerce by allowing electronic transactions with assurances that the digital representation used in the electronic transaction is paired with the physical asset.

Verification, including verification of an event, can include verifying that the physical material and the digital representation match and can be accomplished in a variation of methods including interaction with identification elements such as a tag, label, and the like, capturing an image of the material, capturing a video of the material, capturing indicia such as a tag physically affixed or otherwise associated with the material, human visual inspection, weight measurements at and between events, capturing the dimensions of the physical object at and between events, and any combination. Identification of an individual performing or otherwise associated with an event can be captured by identification devices (e.g., cards, tags, RF ID. smart dust, beacons) and biometrics including visual capture (e.g., facial recognition), voice recognition, iris scan, fingerprint, palm print and any combination.

The system can retrieve object and event information such as harvesting record, receive verification that the raw material delivered to a shipper is the same that was harvested and create a shipping record. A verification that the physical material and the retrieved digital representation match can be performed using a capture device, worker verification and a combination. The metadata associated with delivering the raw material to the shipper can be captured and included in the shipping record. The shipping record can include information about the shipper and the worker delivering the raw material to the shipper. The shipping record can include information about the destination of the raw material. By capturing the shipping event and verifying that the raw material harvest delivered to the shipper and the digital representation are paired, and stored on the immutable storage, the physical material and the digital representation are paired from harvesting the delivery to the shipper allowing for reliance upon the digital record to accurately represent the physical material and its disposition.

The system can retrieve event information such as a shipping record, receive verification that objects such as raw material is delivered by the shipper to a processor (e.g., manufacturer), is the same that was harvested, shipped, and received. The metadata associated with delivering the raw material to the processor can be captured and included in a delivery record. The delivery record can include information about the shipper, processor, worker and any combination. The delivery record can include information about the processor, location, and other information. By capturing the delivery event and verifying that the raw material harvest delivered to the processor and the digital representation are paired, and stored on the immutable storage, the physical material and the digital representation are paired from harvesting the delivery to the processor allowing for reliance upon the digital record to accurately represent the physical material and its disposition.

Once the processor processes the raw material to form a processes material, the system can create a processor record including that the raw material delivered to the processor is integrated into a processed material and is the same raw material that was harvested, shipped, and received. The metadata associated with processing the raw material can be captured and included in a processing record. The processing record can include information about the harvesting, shipping, processor, worker, and any combination. By capturing the processing event and verifying that the raw material harvested delivered to the processor and the digital representation are paired, and stored on the immutable storage, the physical material and the digital representation are paired from harvesting to processing allowing for reliance upon the digital record to accurately represent the physical material and its disposition.

Once processed, the processed material can be further shipped to be included as a component in another material. For example, the raw material can be aggregates, rocks, Portland cement and water. The processed material can be concrete. When an article (material) is made from the concrete, the article can be associated with a digital representation that allows pairing of the article with the raw material and the events through the article process. Therefore, the physical article and the digital representation are paired from harvesting to article creation allowing for reliance upon the digital record to accurately represent the physical article (material) and its disposition.

Referring to FIG. 13C a location 1394 can include the computer device 1395 disposed at a stationary location or the computer device can be portable and disposed at the location. An object 1396 can be at an inventory location 1397 and when used, taken to a event location 1998. The system can record the object and the event wherein the event can include the receipt of the object at the storage locations, use of the object at the event area and a transaction or other event that occurs involving the location or the object. The location 1394 can be geofenced so that the location of an object or event can be compared with the physical location.

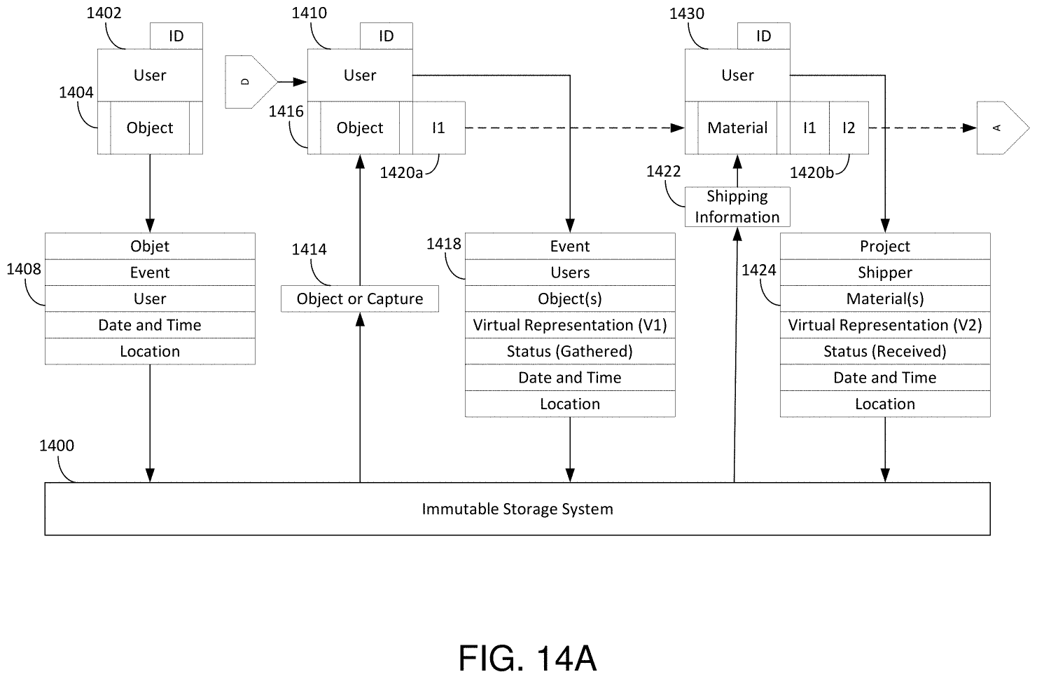

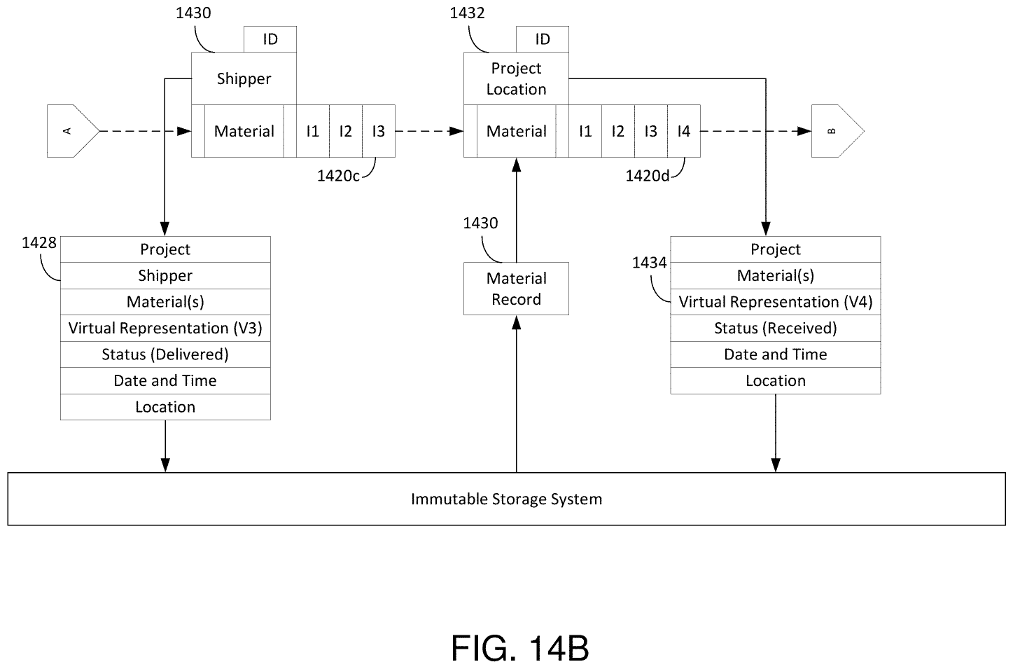

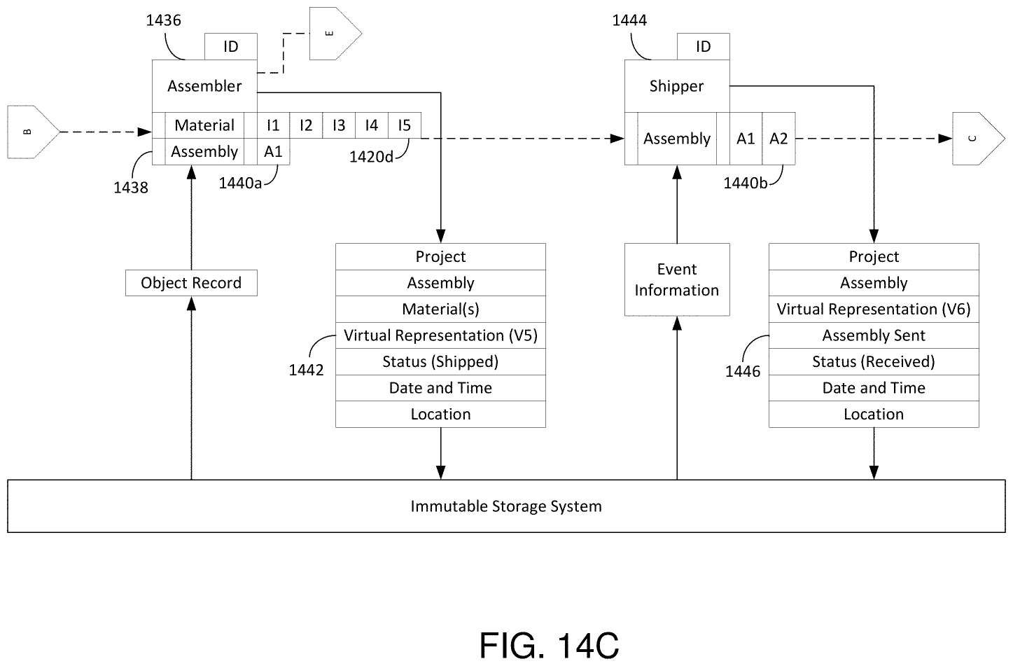

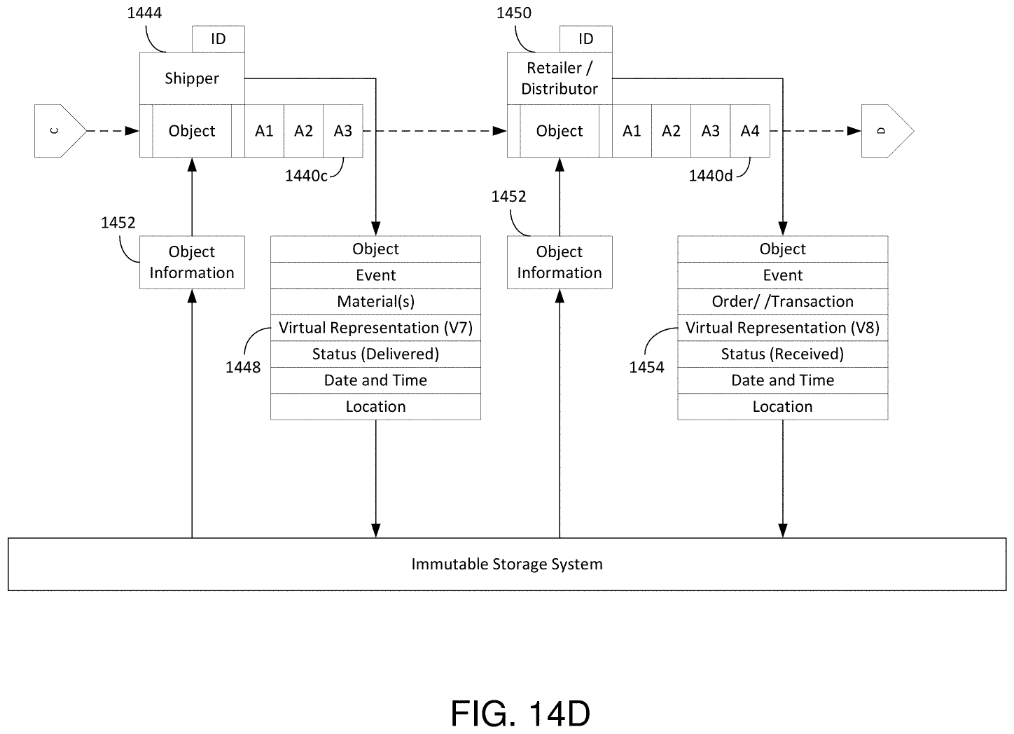

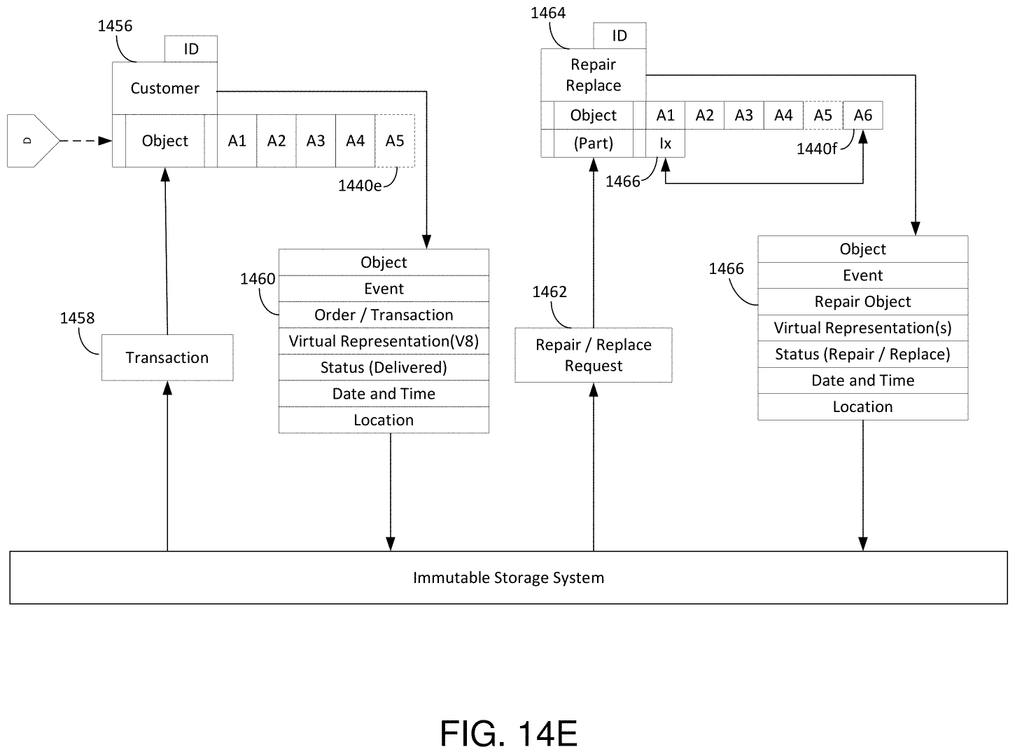

Referring to FIG. 14A through 14E, a user 1402 using a computer system can create object information 1404. The object information and its metadata 1408 can be stored on immutable storage system 1400. A user of the computer device 1410, can select or otherwise acquire object information such 1416 from the immutable storage. The user can verify that the digital representation matches the object information or record, and the system can capture this as an event. The user can also use computer device 1410 and capture an event that can be associated with the object or can stand alone and store the event information 1418 on the immutable storage 1400. For example, one method of associating the object with a digital representation is using a indicia 1420a (I₁) placed on the material. The indicia is then physically verified to be associated with the material from the material list or the material requirement record. Therefore, the physical material and the digital representation (V₁) are paired by recording this event and associating the physical material, I₁, and V₁. In one embodiment, the indicia can include the following information:

| Description | Digits | Information |
|---|---|---|
| Locations | 19-20 | GPS XX.XXXXXX XXX.XXXXXX |
| User ID | 8 | SSN XXXX + Initials XX + Gender X |
| Date | 10 | XX/XX/XXXX |
| Time | 7 | Zulu XXXX:XX |
| Material | 12 | UPC/Barcode XXXXXXXXXXXX |

An event record such as shipping, activity, task or other events 1418 can be created and stored on the immutable storage. The capture event can include a unique number and include the user or object ID, date and time, location, object ID, status, and any combination. The object ID can be from an original manufacturer, the supplier, user, of created by the system. The status can include that the material has been gathered, packaged, ordered, is in stock or on back order, shipping information, transferred, obtained, and the like and in any combination.

A user such as an inspector can retrieve information from the immutable storage identifying the user location, object location and event location. The information can also include task, event, activity, occupants, attendees, origination, destination, pick time, delivery time, and other information concerning the object. The user can verify that the object matches the digital representation of the retrieved record. If the object is verified, the user can physically capture the event, for example, by affixing its indicia 1420b (I₂) to the object representing this verification. A system can create a record 1424 that can be stored on the immutable storage system. This record can include project, shipper, material, status, date, time, location, and any combination. The mode of transportation of the material can also be tracked and stored on the immutable storage. For example, if a shipper uses a vehicle, the date, time, location, and other metadata associated with the vehicle can be gathered along the route and stored on the immutable storage. Verification can be provided using the metadata of the various events. For example, if the date, time, and location of the object and event record is within a certain range of values of the date, time and location of the pickup event, there will be verification that the proper objects were physically transmitted from a supplier to a shipper, for example.

Using the shipping example, the shipper as a user can deliver the material (e.g., object) to the destination such as a project location. When the shipper delivers the materials to the project location, the shipper can capture this event by creating a supplier shipping delivery 1428 record using a shipper computer system. The shipper can verify the event by methods including adding a indicia 1420c (I₃) representing that the proper materials were delivered to the proper location. The project location computer system 1432 can be used to verify that the materials were properly delivered by retrieving the material record 1430 from the immutable storage and using the record to match the physical materials delivered. In one embodiment, the shipper can use the tags that are part of the digital representation to match 13 with the material and the information stored on the immutable storage to capture and verify the event. When the material is delivered, the project location can use a project computer system 1432 to retrieve the material record from the immutable storage and match the material delivered with the material record. The project location can add an indicia 1420d (I₄) to the material to capture this event. The project location can create a project location material received record 1434 that can include the project, material, digital representation (V₄), status, date, time, location, other metadata, and any combination. The shipper, worker at the project location, or both can physically inspect the material and verify that it is matches the digital representation stored on the immutable storage. This verification can be included in the information that is stored on the immutable storage by the shipper and a worker or system at the project location.

Referring to FIG. 14C, and using assembler as a user, materials as objects and the assembly as an event, the project location can be an assembler, or the assembler can be at a separate location from the project. For example, in the manufacturing of a vehicle, the project location can be the assembly line for the vehicle and multiple assembly locations can be involved. The main assembly line can be the project location and the assembler can be a component or sub-component of the manufacturing process. This system can be used for the project, or sub-project that are included in the overall project. Further a sub-project can be treated as a project as discussed herein.

An assembler computer system 1436 can be used to retrieve the material record from the immutable storage. The material record can be used to match the materials delivered to the assembler to verify that the proper materials were received by the assembler. The assembler can add indicia 1420d (I₅) to the material, or use other verification methods described herein, to capture the event. The assembler can also capture the material used and the assembly 1438 by adding a indicia 1440a (A₁) to the assembly. An assembler record 1442 can be created and stored on the immutable storage. The assembler record can include the project, assembly description and other information, assembler, material(s) used, digital representation, shipping information date, time, location of the assembly, other metadata, and any combination.

One verification can be the comparison of an image of the physical object taken at the first event and the image of the physical object taken at the second event. In one embodiment, the determination if the two images represent the same physical object can be made by comparison the distance between the images. The distance between the images of the two object captures do not have to be identical but can be defined by the “closeness” between the images. In one embodiment, the distance can use the Euclidean distance between the l^{th} and j^{th} physical object. Distance between the p-dimensional vectors can be represented as:

$${d}_{E} ( i , j ) = \sqrt{( {\sum }_{k = 1}^{p} {( {x}_{i k} - {x}_{j k} )}^{2} )} \qquad ( 1 )$$

or by using the weighted Euclidean distance that can be represented as:

$${d}_{E} ( i , j ) = \sqrt{( {\sum }_{k = 1}^{p} {w}_{k} {( {x}_{i k} - {x}_{j k} )}^{2} )} \qquad ( 2 )$$

Where d_{E}=distance, i=first image, j=second image, and w=weight between kth measure which can be subject to the following

0<wᵢ<1 and Σᵢ₌₁ⁿ1 (3)

In one embodiment, the verification process can include an individual retrieving the first image of the physical object and comparing the first image with the physical object in proximity of the individual. The individual can review the first event record and the second event record to also make a determination of the physical object has remained the same from the first event to the second event. Information. In one embodiment, multiple individual and computer system can make the comparison. The comparison can also be crowd sourced so that multiple verifications are made from an individual computer system and any combination.

Once completed, the assembly may need to be delivered to another location. The assembler record can include shipping information, or an assembly shipping record can be created and stored on the persistent record. If the assembly needs to be delivered, a second shipper can use a second shipper computer system 1444 to retrieve the shipping record, assembler record or other shipping information that is used to identify the origin, locations, assembly, pick up time, delivery time and other information associated with the transportation of the assembly from one location to another. The assembly can be received by the second shipper and the second shipper can capture the event such as with a indicia 1440b (A₂) to the assembly representing that the assembly has been verified by the second shipper as properly provided and received by the shipper. A second shipper pick up record 1446 can be created and stored on the immutable storage.

Referring to FIG. 14D, the second shipper can deliver the assembly to a retailer, distributor, or customer. The assembly can be a component to be further used or a final product. When the second shipper delivers the assembly to a retailer or distributor, the second shipper can create a second shipper delivery record 1448 using a second shipper computer system 1444. The second shipper can capture the event such as using a indicia 1440c (A₃) representing that the proper assembly was delivered to the proper location. The second shipper can use the verifications that are part of the digital representation to match A₃ with the material and the information stored on the immutable storage.

The retailer or distributor computer system 1450 can be used to verify that the materials were properly delivered by retrieving the assembly record 1452 or second shipper record 1448 from the immutable storage and using the record to match the physical assembly delivered. The retailer or distributor can capture the event and can add a indicia 1440d (A₄) representing that the proper assembly was received at the proper location. A retailer distributor record 1454 can be created and stored on the immutable storage.

Referring to FIG. 14E, a user (e.g., customer, buyer and sports fan) can receive an object and by using a computer system 1456 retrieve or otherwise receive the object or capture record 1458 from the immutable storage or other system. The user can be provided the object using the system as described herein with a user performing the steps and the system performing the steps associated with the transfer of the object. Another user can create a subsequent event record representing a third shipper pickup and delivery record that can be stored on the immutable storage verifying that the assembly was properly provided from the supplier. The user may capture the event and can add an indicia 1440e (A₅) to the object that can be associated with the digital representation (V₈). A capture record 1460 can be stored on the immutable storage reflecting the object and event.

Using this system, the user can be assured that the object was independently verified and authenticated from the design to the delivery to the user and that the digital representation of the assembly and its components (e.g., materials) are paired.

In one embodiment, where the event can be a repair request 1462 can be created and stored on the immutable storage system. The repair request can be associated with the assembly and retrieved by a repair computer system 1464. The repair company can receive a part using the system described herein, perform a repair or replacement action, and capture the event such as by using a indicia 1440f (A₆) to the assembly indicating that the assembly has had a part repaired or replaced. The repair part can also have a preexisting indicium from the use of the system herein and the repair company can capture the event such as by using a indicia (Ix). A repair record 1466 can be created and stored on the immutable storage.

The system described herein can pair the physical material and/or assembly with a digital representation. Failure to pair the physical material or assembly with the digital representation can negatively impact areas such as regulatory requirements. Regulatory requirements are a set of rules that can specify the standards for a project. Regulatory requirements impact designs, materials, worker's license and experience the project and process. For example, a building code may require that construction materials be installed in accordance with manufacturer's specifications and warranty regulations. Failure to follow the building codes can result in the project not being approved, errors, lack of customer satisfaction, insurance claims, injury, litigation, and other negative ramifications. Tracking, management, and verification of materials to ensure compliance with regulatory requirements and proper installation according to applicable specifications is an important aspect to many projects and processes. Tracking and record keeping during the project or process can be beneficial, as it can be difficult to perform these tasks after project or process completion because the materials can be hidden from view or otherwise inaccessible. For example, electrical wiring in a project or process can be hidden behind walls and ceilings once the project is complete.

Systems at multiple locations may be interconnected using image capture devices, RFID, QR codes, barcodes, biometric scanners, still cameras, video cameras, and the like to identify individuals or machines that are performing verifications during the process. Further, multiple individuals or machines are performing verifications so that there is not a reliance upon any one entity for verifications. The processing of capturing data, including images, from the multiple systems at multiple locations can be used to improve the verification of proper materials and assemblies as well as to pair the physical items with the digital representation.

Verification of processes, inspections, completions and deliveries with adjustments and notifications (manual and automated) with confirmation would ensure increased productivity, especially if accessible in real time at the location. Real time processes and procedures planned with corresponding training and manuals would improve quality control and efficiency. This has been a long felt need in the prior art that has not been satisfied with a controller that is uniquely associated with an asset location.

Automated verification of quantities, quality, and correct product deliveries along with after delivery tracking of materials with accountability is seldom used. Designated delivery areas with geofenced control and tracking of materials once delivered would help prevent loss. Confirmation of products integrated at the asset location provides transparency regarding sourcing, warranties, as well as future reference during the structure and individual product's life of use.

By using the various tags and digital representations, each entity in the process can verify that the physical materials match any record the precedes that entity.

This process can include internal and external individuals and machines for performing inspections (e.g., verifications). For example, the system can receive a set of internal inspection information entered into the system from an internal inspector representing an internal physical inspection of the project, material or assembly. As the items travel, an internal inspector can provide inspection information representing the stages of the project. The system can also receive a set of external inspection information from an external inspector and an external inspection computer device representing a third-party physical inspection of the project at predetermined stages of the project. Based upon the internal inspection, external inspection or both, an inspection record can be created and stored on the immutable storage.

The verified pairing described herein can also be used to verifiable pair physical assets with installation instructions, storage instructions, warranties, ownership, service, maintenance, and any combination thereof.

The system can also facilitate the use of digital wallets or other digital storage technologies. The information that is contained on the digital wallet can be paired with a physical object so that transactions associated with the physical object can be conducted with verification that the digital representation in the digital wallet represents the physical object, whether the physical object is fungible or unique.

computer system in communication with an immutable storage; a first computer device in communications with the computer system; a second computer device in communications with the computer system; a set of computer readable instructions included in the computer system configured for: receiving an event record (E₁) from the first computer device including a first location (L₁), a first time (T₁) and a first set of metadata (M₁) wherein the first set of metadata includes an original digital representation captured by the first computer device of the physical object, receiving a subsequent event record (E₂) from the second computer device including a second location (L₂), a second time (T₂) temporally subsequent to the first time and a second set of metadata (M₂) wherein the second set of metadata includes a subsequent digital representation captured by the second computer device of the physical object, and, determining if the original digital representation is equivalent to the subsequent digital representation thereby providing for verification that the same physical object transitioned from an originating event to a subsequent event.

The event record can include a verification code that can be used to verify that the data in the event record remains accurate from its creation of from another time. The verification can have several constructions including checksum. A checksum can be small block of data, usually digital, derived from another block of digital data configured for use for detecting errors that can occur transmission, storage or unintentional or intentional tampering with the data. A first record can have a first checksum. A second record can have a second checksum. The second checksum can be derived from the first and the second record so that alteration of the first or second record can be detected with the second checksum.

The verification can be a hash. A hash can be a mathematical function that is configured to converts an input, such as a data record, into an encrypted output, typically having a fixed length. Therefore, a unique hash can be the same size regardless of the size of amount of the input (e.g., data). Further, the hash can be configured to prevent reverse-engineering of the input because the hash functions is a one-way function. When analyzing a record, such as an event record, comparing a first hash that can be created and stored with the event record and a second hash calculated when the event record is retrieved can provide validation that the data is unaltered from storage to retrieval. The verification code can be the hash.

The event record can also include the validation code that is created according to a set of validation rules. These rules can control what information can be included in a record and verification that the record includes data or at least the type of data that is contained in the record. Validation rules can include data type, code type, range check, format check, consistency check and uniqueness check. These rules can be used to both assist with the type of data inputted and whether the data has been altered from storage to retrieval. Validation can also be performed with sampling a subset of data or records from a database and extrapolating accuracy of the data from origin creation to storage through retrieval.

In one example, a data record is an input that is processed with computer readable instructions configured with a hashing algorithm that can include a secure hashing algorithm, message digest algorithm, Keccak, RACE integrity primitives evaluation message digest, Whirlpool, BLAKE, and the like and any combination. The output can be a first verification code and that first verification code is stored on an immutable ledger or other secure location. The hashing algorithm can be deterministic so that the input will results in the same output. The hashing algorithm can be configured to prevent the ability to see or read the data that is the original input. The hashing algorithm can be configured so that a small change, even one byte, will change the output. Therefore, the first output of the data will not match the second output if the data is changed between when the first data and the second data is determined.

The set of computer readable instructions can include instructions for determining if a similarity between the original digital representation and the subsequent digital representation is within a predetermine range. The first computer device can be remote from the computer system. The subsequent event record can include a verification data representing that verification of the physical object subject to the subsequent event is the same physical object associated with the originating event according to the first event record. The set of computer readable instructions can include storing the first event record on the immutable storage and the set of computer readable instructions for determining if the first digital representation is equivalent to the subsequent digital representation includes retrieving the first event record from the immutable storage. The subsequent event record can include a verification data representing that an individual viewed the metadata of the first event record and compared it with the physical object. The second set of metadata is taken from sources from the group consisting of public records, enterprise software, computer device or any combination thereof.

The computerized system can include a computer system in communication with an immutable storage; a set of computer readable instructions included in the computer system configured for: retrieving a first event record (E₁) from the immutable storage wherein the first event record includes first location (L₁), a first time (T₁) and a first set of metadata (M₁) wherein the first set of metadata includes a first digital representation captured by a first computer device of the physical object, retrieving a subsequent event record (E₂) from the immutable storage including a second location (L₂), a second time (T₂) temporally subsequent to the first time and a second set of metadata (M₂) wherein the second set of metadata includes a subsequent digital representation captured by a second computer device of the physical object, and, determining if a similarity exists between the original digital representation and the subsequent digital representation is within a predetermine range.

The set of computer readable instructions can include instructions for determining if the physical object is the same physical object represented by the first digital representation during an occurrence of a second event. The subsequent event record can include a verification data representing that verification of the physical object subject to the subsequent event is the same physical object associated with the first event. The subsequent event record can include a verification data representing that an individual viewed the metadata of the first event record and compared it with the physical object. The first computer device can be a remote from the computer system and the second computer device.

The system can include for verifiably pairing a physical object with a digital representation comprising: a computer system in communication with an immutable storage; a computer device in communications with the computer system; a set of computer readable instructions included in the computer system configured for: retrieving a first event record (E₁) from the immutable storage wherein the first event record includes a first location (L₁), a first time (T₁) and a first set of metadata (M₁) wherein the first set of metadata includes a first digital representation captured by a first computer device of the physical object, creating a subsequent event record (E₂) from the computer device including a second location (L₂), a second time (T₂) temporally subsequent to the first time and a second set of metadata (M₂) wherein the second set of metadata includes a second digital representation captured by the computer device of the physical object, and, determining if a similarity between the first digital representation and the second digital representation exists.

The computer readable instructions can include instruction for determining if the similarity is within a predetermine range. The computer readable instruction can include instructions for determining if a similarity between the first digital representation and the second digital representation exists includes retrieving the first event record from the immutable storage. The subsequent event record includes a verification data representing that verification of the physical object subject to the subsequent event is the same physical object associated with the first event according to the first event record. The computer device can be a first computer device; and the computer readable instruction can include instructions for determining if a similarity between the first digital representation and the second digital representation exists includes retrieving a first image of the physical object, comparing the image to a second image captured by a second computer device and determining if the images represent the same physical object. The instructions can determine if a similarity between the first digital representation and the second digital representation exists includes capturing an object indicium affixed to the physical object, comparing the indicium on the object at the subsequent event to a digital indicium included in the first event record. The subsequent event record can include a verification data representing that an individual viewed the object indicium and compared it with the digital indicium retrieved from the immutable storage and included in the first event record.

In one embodiment, the system can provide a hashed event record where the event record can include metadata associated with a capture device as well as indicium associated with the physical object and store the record on a blockchain platform including the platforms associated with Bitcoin, Ethereum and the like.

What is claimed is:

1. A system for digitally recording, verifying, and storing objects and events comprising:
a computer device in communications with an immutable storage system;
a capture device in communication with the computer device;
a set of computer readable instructions that when processed by the computer device are adapted to:
receive a user information representing a user of the computer device,
capture an object information representing an object using the capture device wherein the object information includes object metadata according to an object location information and an object temporal information,
capture an event identification information representing an event wherein the event identification information includes event metadata according to an event location information and an event temporal information,
create a capture record according to the user information, object information, event information, and any combination thereof, and
store the capture record on the immutable storage system.

2. The system of claim 1 including a digital storage and the set of computer readable instructions are adapted to associate the digital storage with the user information and associate the capture record with the digital storage.

3. The system of claim 2 wherein the set of computer readable instructions are adapted to receive a unique identifier and associate the unique identifier with the capture record and the digital storage.

4. The system of claim 1 wherein the set of computer readable instructions adapted to receive a unique identifier creates the unique identifier.

5. The system of claim 1 wherein the object is a physical object and the object information include a digital representation of the physical object.

6. The system of claim 1 wherein the user information includes user metadata according to a user location information and user temporal information.

7. The system of claim 1 wherein the set of computer readable instructions are adapted to create a validation information according to a comparison of the object metadata and the event metadata.

8. The system of claim 7 wherein the validation information is included in the capture record.

9. The system of claim 1 wherein the user information includes user metadata according to a user location information and a user temporal information.

10. The system of claim 9 wherein the set of computer readable instructions are adapted to create a validation information according to a comparison of the object metadata, the event metadata, the user information, and any combination thereof.

11. The system of claim 1 wherein the set of computer readable instructions are adapted to receive remote temporal information from a remote temporal source and create a verification information according to a comparison of the object temporal information, the remote temporal information, the event temporal information and combination thereof.

12. The system of claim 1 wherein the computer device is configured to determine the object information from a global positioning service, wireless access point, cell tower, IP address and any combination thereof at a time the object information is captured.

13. The system of claim 1 wherein the computer device is configured to determine the event information from a global positioning service, wireless access point, cell tower, IP address and any combination thereof at a time the event information is captured.

14. The system of claim 1 wherein the user information is a first user information representing a first user and the set of computer readable instructions are adapted to:
receive a second user information representing a second user of the computer device,
retrieve the capture record,
receive a verification information using the capture device wherein the verification information represents a determination that the object information accurately represents the object, and the verification information includes verification metadata according to a verification location information and a verification temporal information, and
create a verification record according to a comparison of the capture record and the verification information.

15. The system of claim 14 wherein the set of computer readable instructions are adapted to create the verification information according to a determination that the object location information and the verification location information are within a predetermined range.

16. The system of claim 14 wherein the set of computer readable instructions are adapted to create the verification information according to a determination that the object temporal information and the verification temporal information are within a predetermined range.

17. The system of claim 1 wherein the user information is a first user information representing a first user and the set of computer readable instructions are adapted to:
receive a second user information representing a second user of the computer device,
retrieve the capture record,
receive a verification information using the capture device wherein the verification information represents a determination that the event identification information accurately represents the event, and the verification information includes verification metadata according to a verification location information and a verification temporal information, and
create a verification record according to a comparison of the capture record and the verification information.

18. The system of claim 17 wherein the set of computer readable instructions are adapted to create the verification information according to a determination that information and the verification location information are within a predetermined range.

19. The system of claim 17 wherein the set of computer readable instructions are adapted to create the verification information according to a determination that the event temporal information and the verification temporal information are within a predetermined range.

20. The system of claim 1 wherein the user information is a first user information representing a first user and the set of computer readable instructions are adapted to:
receive a second user information representing a second user of the computer device,
retrieve the capture record,
receive a verification information using the capture device wherein the verification information represents a determination that the first user information accurately represents the first user, and the verification information includes verification metadata according to a verification location information and a verification temporal information, and
create a verification record according to a comparison of the capture record and the verification information.

21. The system of claim 20 wherein the user information includes a user location information, and the set of computer readable instructions are adapted to create the verification information according to a determination that the user location information and the verification location information are within a predetermined range.

22. The system of claim 20 wherein the user information includes a user temporal information, and the set of computer readable instructions are adapted to create the verification information according to a determination that the user temporal information and the verification temporal information are within a predetermined range.

23. A system for digitally recording, verifying, and storing objects and events comprising:
a computer device in communications with an immutable storage system;
a capture device in communication with the computer device;
a set of computer readable instructions that when processed by the computer device are adapted to:
receive a user information representing a user of the computer device,
capture an object information representing an object using the capture device wherein the object information includes object metadata according to an object location information and an object temporal information,
create a capture record according to the user information, object information, and any combination thereof, and
store the capture record on the immutable storage system.

24. The system of claim 23 wherein the object information is a first object information, the capture record is a first capture record and the set of computer readable instructions are adapted to capture a second object information and create a second capture record according to the user information, the first object information, the second object information and any combination thereof.

25. The system of claim 23 wherein the set of computer readable instructions are adapted to capture event information associated with the object wherein the object information includes event metadata according to an event location information and an event temporal information.

26. A system for digitally recording, verifying, and storing objects and events comprising:
a computer device in communications with an immutable storage system;
a capture device in communication with the computer device;
a set of computer readable instructions that when processed by the computer device are adapted to:
receive a user information representing a user of the computer device,
capture an event identification information representing an event wherein the event identification information includes event metadata according to an event location information and an event temporal information,
create a capture record according to the user information, event information, and any combination thereof,
store the capture record on the immutable storage system.

27. The system of claim 26 wherein the event information is a first event information, the capture record is a first capture record and the set of computer readable instructions are adapted to capture a second event information and create a second capture record according to the user information, the first event information, the second event information and any combination thereof.

28. A system for digitally recording, verifying, and storing objects and events comprising:
a computer device in communications with an immutable storage system;
a capture device in communication with the computer device;
a set of computer readable instructions that when processed by the computer device are adapted to:
receive a first user information representing a first user of the computer device,
capture an object identification information representing an object associated with the first user wherein an includes object metadata according to an object location information and an object temporal information,
create a capture record according to the first user information, object information, and any combination thereof,
store the capture record on the immutable storage system,
receive a second user information representing a second user of the computer device, and,
receive verification information representing that the object identification information represents the object.

29. The system of claim 28 wherein the computer device is adapted to receive a computer device location information and the verification information includes a comparison of the computer device location information and the object location information.

30. The system of claim 28 wherein the computer device is adapted to receive a computer device temporal information and the verification information includes a comparison of the computer device temporal information and the object temporal information.
